(19) United States
(12) Patent Application Publication
(10) Pub. No.: US 2025/0162283 A1
(43) Pub. Date: May 22, 2025

(54) CEMENT PANEL AND METHOD TO ELIMINATE RELEASE PAPER FROM CEMENT PANEL MANUFACTURE

(71) Applicant: UNITED STATES GYPSUM COMPANY, Chicago, IL (US)

(72) Inventors: Ashish DUBEY, Grayslake, IL (US); Yanfei PENG, Hawthorn Woods, IL (US); Richard Zheng Jun LIU, Palatine, IL (US); James Brendan O'SULLIVAN, Lake Zurich, IL (US); Eugene Scott STIVENDER, Yorkville, IL (US)

(21) Appl. No.: 18/660,717

(22) Filed: May 10, 2024

Related U.S. Application Data
(60) Provisional application No. 63/600,959, filed on Nov. 20, 2023.

(51) Int. Cl. B32B 13/14; B32B 3/04; B32B 5/02; B32B 5/26; B32B 13/02; B32B 37/15; E04C 2/28

(52) U.S. Cl. CPC B32B 13/14; B32B 3/04; B32B 5/022; B32B 5/269; B32B 13/02; B32B 37/15; E04C 2/28; B32B 2260/021; B32B 2260/044; B32B 2262/0253; B32B 2262/101; B32B 2264/101; B32B 2264/403; B32B 2305/18; B32B 2307/718; B32B 2307/7376; B32B 2315/06; B32B 2607/00

(57) ABSTRACT

A building composite panel including a core of a continuous phase comprising hydraulic binder. The core has first and second opposed longitudinal edge faces, and opposed first and second major faces, each major face adjoining the first and second opposed longitudinal edge faces. A slurry-permeable reinforcing material is attached to the first major face. A non-woven polymer fabric laminate facing material, that is different from the reinforcing material, covering and attached to and traversing the first major face and covering and attached to the opposed longitudinal edges of the core. The facing material includes a plurality of bonded laminas, wherein the plurality includes a first and second water-permeable laminas on opposed outer sides of the facing material, and a water-impermeable lamina between the first and second water-permeable laminas. The first water-permeable lamina attached to the core. A method for making the panel is also provided.

### FIELD OF THE INVENTION

This invention relates to composite cement building panels, also known as cement boards, having a laminate facing, the facing comprising a plurality of bonded lamina. This invention also relates to a cost-effective, novel method to eliminate release paper used in cement panel manufacturing.

### BACKGROUND OF THE INVENTION

Composite building panels such as drywall panels or cement boards are frequently used to enhance construction productivity by reducing time spent waiting for hydraulic binder to set and dry. Conventional drywall panels, which are primarily made of gypsum, are particularly useful for interior construction of walls and ceilings. Precast cement boards are useful where strength or stability is desired, such as an underlayment for ceramic tile.

Many building panels are constructed with facing or reinforcing materials on one or more faces of the panel. Facing materials are commonly used to alter one or more physical properties of the panel. In the case of drywall, the material on the face exposed after installation provides a smooth surface that is receptive of decorative coatings such as paint or wallpaper. Reinforcing of the edge with facings provides strength where panels are nailed into place. Cement board panels utilize facings that hold fast to adhesives, both to hold the panel in place and to tightly bond the panel to decorative finishes such as flooring tiles.

U.S. Pat. No. 7,846,536 discloses a building composite panel including at least one longitudinal edge face, comprising: a core of hydraulic material having a top major face and a bottom major face, each major face adjoining the longitudinal edge face; a slurry-permeable reinforcing material attached to one or more of said major faces; and, a multi-ply edge facing material, that is different from said reinforcing material, covering and attached without adhesives to said at least one longitudinal edge face and attached to only a portion of each of said major faces, said edge facing material overlapping said reinforcing material and said top major face and said bottom major face, and comprising at least a slurry-permeable first ply embedded in said longitudinal edge face and a second, slurry-impermeable ply bonded to said first ply, wherein between about 10% and about 50% of the width of the edge facing overlaps with the first reinforcing material. However, the method for manufacturing the cement board includes applying the cement slurry to release paper and after the cement board sets, discarding the release paper.

Cement boards are typically made by depositing a cement slurry on release paper, allowing the cement to set in the form of a panel (board), and then removing the release paper. The release paper aids with the formation of cement board including cement board edges in a continuous manufacturing process. The release paper is also instrumental in preventing material buildup on the continuous forming belt and the edge forming equipment. However, the release paper utilized in cement board manufacturing is single-use only and has a significant impact on product's sustainability attributes and environmental footprint.

### SUMMARY OF THE INVENTION

The invention provides a cement board having a multi-lamina fabric laminate sheet on at least edges and one major face between the edges. This replaces the release paper with a unique composite fabric laminate to form the product in continuous operation. The composite fabric material (also described herein as a polymer fabric laminate facing material) becomes a part of the manufactured cement board and does not need to be removed at the end of the manufacturing line after the cement board slurry has set and hardened.

In particular, the invention provides a building composite panel, comprising:
a core of a continuous phase comprising set hydraulic binder, wherein the core comprises first and second opposed longitudinal edge faces, and opposed first and second major faces, each major face adjoining the first and second opposed longitudinal edge faces;
a slurry-permeable reinforcing material attached to the first major face, and optionally attached to the second major face; and,
a polymer fabric laminate facing material, that is different from the reinforcing material, covering and attached, preferably without adhesives, to:
the first and second longitudinal edge faces,
an entire width of the first major face from the first longitudinal edge face to the second longitudinal edge face, and
at least opposed first and second end portions of the second major face adjoining the first and second opposed longitudinal edge faces,
wherein the polymer fabric laminate facing material overlaps the reinforcing material, and
wherein the polymer fabric laminate facing material comprises a plurality of bonded overlapping laminas comprising at least:
a slurry-permeable first lamina,
a slurry-impermeable second lamina, and
a slurry-permeable third lamina,
wherein the slurry-permeable first lamina and the slurry-permeable third lamina form opposed surfaces of the polymer fabric laminate facing material,
wherein the slurry-impermeable second lamina is between the slurry-permeable first lamina and the slurry-permeable third lamina,
wherein the slurry-impermeable second lamina has opposed surfaces, and each of the opposed surfaces of the slurry-impermeable second lamina is directly bonded to a respective lamina of said plurality of laminas,
wherein the slurry-permeable first lamina is embedded in:
the first and second longitudinal edge faces,
an entire width of the first major face from the first longitudinal edge face to the second longitudinal edge face, and
at least opposed first and second end portions of the second major face adjoining the first and second opposed longitudinal edge faces;
where at least the first lamina is a first web of nonwoven fibers and at least the second lamina is a second web of non-woven fibers.

The invention also provides a method of providing a panel of the invention, comprising:
depositing the polymer fabric laminate facing material of the invention directly on a moving forming surface to contact the moving forming surface without a release paper between the polymer fabric laminate facing material and the moving forming surface,
wherein the polymer fabric laminate facing material comprises a plurality of bonded overlapping laminas comprising at least:
a slurry-permeable first lamina,
a slurry-impermeable second lamina, and
a slurry-permeable third lamina,
wherein the slurry-permeable first lamina and the slurry-permeable third lamina form opposed surfaces of the polymer fabric laminate facing material,
wherein the slurry-impermeable second lamina is between the slurry-permeable first lamina and the slurry-permeable third lamina,
wherein the slurry-impermeable second lamina has opposed surfaces, and each of the opposed surfaces of the slurry-impermeable second lamina is directly bonded to a respective lamina of said plurality of laminas,
depositing the slurry-permeable reinforcing material onto the slurry-permeable first lamina of the polymer fabric laminate facing material,
depositing a layer of an aqueous slurry comprising water and reactive powder, for setting to become the set hydraulic binder of the core of the panel, on the slurry-permeable reinforcing material, wherein the reactive powder comprises cement, optionally β-stucco, and optionally pozzolanic material, and
folding respective opposed side portions of the polymer fabric laminate facing material around the first longitudinal edge face and the second longitudinal edge face to extend to an upper surface of the deposited slurry,
embedding the slurry in the slurry-permeable first lamina of the polymer fabric laminate facing material; and
forming and setting the aqueous slurry comprising reactive powder to form the set hydraulic binder for the core while there is an absence of release paper between the forming surface and the polymer fabric laminate facing material;
where at least the first lamina is a first web of nonwoven fibers and at least the second lamina is a second web of non-woven fibers.

The composite fabric laminate utilized to form the product also replaces the strips of fabric material that are currently used to form and reinforce the cement board edges. The composite fabric laminate materials of the present invention are cost effective and eliminate the need for the release paper currently used in cement board manufacture. The various benefits provided by the composite fabric laminates of the invention in manufacture of cement board include elimination of release paper use, low capital cost requirement to implement the technology, enhanced product manufacturability, prevention of panel blocking (panels sticking to each other when stacked on a unit), improved production efficiencies, reduced production delays and waste, uniform and enhanced product appearance, provision of printable (or pre-printed) surfaces, novel and differentiated product design, enhanced sustainability attributes for the product and manufacturing process.

Cementitious panels with lightweight density are preferred. Lightweight products of this invention, for example lightweight board, preferably have a having a density in the range of about 30 to 120 pcf, more preferably less than 90 pcf, and most preferably less than 60 pcf. The panels being set, cured, and hardened. The preferred flexural strength of the panels ranges between 400 to 2500 psi when tested per the ASTM C947-03 (Last Updated May 24, 2023) standard.

Preferably the panels, on a 0.15 to 2 inches, preferably 0.20 to 1.00 inches, most preferably 0.25 to 0.75 inches thick basis, have an area density less than 5 pounds per sq.ft., more preferably less than 4 pounds per sq.ft., and most preferably less than 3 pounds per sq.ft.

Obtaining lightweight density is assisted by employing (i) expanded perlite employing special attributes, expanded clay, shale, and/or expanded plastic beads and (ii) air entrainment. The entrained air represents 10-50% of composite volume on a wet basis. Air-entrainment in the compositions of the invention is provided by means of suitable surfactants that form a stable and uniform structure of air voids in the finished product.

All percentages, ratios and proportions herein are by weight, unless otherwise specified. Also, any average molecular weights are weight average molecular weight unless specified otherwise.

For purposes of this description setting of the composition is characterized by initial and final set times, as measured using Gilmore needles specified in the ASTM C266-21 (last updated Nov. 5, 2021) test procedure. The final set time also corresponds to the time when a cement-based product, e.g. a cement board, has sufficiently hardened so that it can be handled. It will be understood by those skilled in the art that curing reactions continue for extended periods after the final setting time has been reached. Rapid set is typically a final set time (i.e., the time after which cement boards can be handled) of the cementitious composition as measured according to the Gilmore needle test that should be at most 20 minutes, more preferably at most 15 minutes, or at most 10 minutes, typically 5 to 10 minutes, after mixing. Final set time measured by the Gilmore needle method according to ASTM C266-21 was the time when no mark was left on a test sample mixture when the Gilmore needle was slowly lowered to the surface of the mixture.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

### BRIEF DESCRIPTION OF THE DRAWINGS

FIG. 1 is a cement building panel of the present invention.

FIG. 2 is a cross section of the building panel taken along the line 2-2 of FIG. 1 and in the direction indicated.

FIG. 2A is a cross section of the building panel taken along the line 2-2 of FIG. 1 and in the direction indicated modified to have two separate reinforcement sheets.

FIG. 3 is a cross section of a SSMMS Laminate polymer fabric laminate facing material.

FIG. 3A is a cross section of a SMS Laminate polymer fabric laminate facing material.

FIG. 3B schematically shows a board manufacturing line.

FIG. 4A is a photograph showing Blocking testing for Example 1 (water/cementitious material ratio (w/cm)−0.46) for a Control Sample with No Fabric.

FIG. 4B is a photograph showing Blocking testing for Example 1 (w/cm−0.46) for a Sample with 15 gsm SSMMS Fabric (Polymer Composite Laminate #2).

FIG. 4C is a photograph showing Blocking testing for Example 1 (w/cm−0.46) for a Sample with 22 gsm SSMMS Fabric (Polymer Composite Laminate #1).

FIG. 5A is a photograph showing slurry bleed through with 15 gsm SSMMS Fabric (Polymer Composite Laminate #2) for Example 1.

FIG. 5B is a photograph showing slurry bleed through with 22 gsm SSMMS Fabric (Polymer Composite Laminate #1) for Example 1.

FIG. 6A is a photograph showing Blocking testing for Example 2 (w/cm−0.50) for a Control Sample with No Fabric.

FIG. 6B is a photograph showing Blocking testing for Example 2 (w/cm−0.50) for a Sample with 15 gsm SSMMS Fabric.

FIG. 7A is a photograph showing Blocking testing for Example 3 for a Control Sample with No Fabric.

FIG. 7B is a photograph showing Blocking testing for a Sample with Fabric LWT.

FIG. 7C is a photograph showing Blocking testing for a Sample with Fabric HVY.

FIG. 7D is a photograph showing delaminated Fabric HVY.

FIG. 8A shows slurry bleed through with 15 gsm SSMMS Fabric (Polymer Composite Laminate #2) for Example 4.

FIG. 8B shows slurry bleed through with 22 gsm SSMMS Fabric (Polymer Composite Laminate #1) for Example 4.

FIG. 9A shows Blocking testing results for Control Sample, without the fabric for Example 5.

FIG. 9B shows Blocking testing results for Laminate A: SSMMS 13 gsm Uniform for Example 5.

FIG. 9C shows Blocking testing results for Laminate B: SSMMS 15 gsm Uniform for Example 5.

FIG. 9D shows Blocking testing results for Laminate C: SSMMS 15 gsm Uniform/Soft for Example 5.

FIG. 9E shows Blocking testing results for Laminate D: SSMMS 17 gsm Uniform/Soft for Example 5.

FIG. 10A shows a panel with fabric laminate (22 gsm Polymer Composite Laminate #1) on the back showing no blocking or panel damage on the panel back surface.

FIG. 10B shows a panel with fabric laminate (22 gsm Polymer Composite Laminate #1) on the back showing no blocking or panel damage on the panel front surface.

### DETAILED DESCRIPTION OF THE INVENTION

The invention provides an improved method for making a cement board without using release paper and the improved cement board resulting from the method.

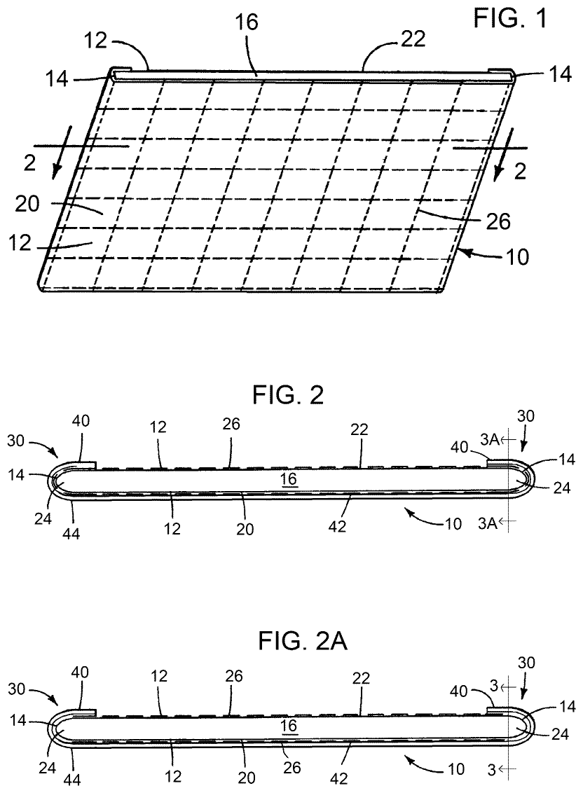

Referring to FIG. 1, a building composite cement panel, generally 10, has a pair of opposing major faces, generally 12, two longitudinal edge faces 14 and a core 16 of set hydraulic binder.

Each panel 10 has a core 16 of hydraulic binder that reacts when added to water to form a set hydraulic binder as a matrix of interlocking crystals. Hydraulic binders preferred for use as core 16 material, include Portland cement, silica cement, fly ash cements, pozzolans, calcined gypsum, other cements and mixtures thereof. Other embodiments of this panel 10 use calcined gypsum as the core 16 material to make gypsum boards for interior use. Panels 10 using gypsum cements, that are a combination of calcined gypsum and a hydraulic cement, are advantageously used for flooring or for exterior use. These are but examples of building panels 10 that can be used advantageously with the present invention and are not intended to limit the invention in any way. The size of the panels 10 varies with the application with which the panel 10 is used, and any suitable size is useful with the panel of the instant invention.

Any core 16 additives known for use in building panels are useful in the present panels 10. Common additives include foaming agents, defoamers, set modifying agents, thickeners, colorants, rheology modifiers and the like. Choice of additives will depend on the core 16 composition and the intended application for the finished panels.

The panel 10 includes the two longitudinal edge faces 14. Preferably, the panels 10 are manufactured in a continuous fashion and cut to a desired size. Where there are two longitudinal edge faces 14 oriented as in FIG. 2, they are generally parallel to each other on opposing sides of the panel 10, but are not necessarily so. The longitudinal edge face 14 has a height that is the thickness of the panel 10 and a width equal to the length of the panel on the side that forms the longitudinal edge face.

Referring now to FIGS. 1 and 2, preferably, the building panel 10 has multiple additional faces, including a pair of opposed major faces 12, referred to as a bottom major face 20 and a top major face 22, respectively, or referred to as a first major face 20 and a second major face 22, respectively. The bottom major face 20 and the top major face 22 each have a length which is the length of the building panel 10 and a width which, is in the direction transverse to the length of the panel, and extends from one longitudinal edge face 14 to the other longitudinal edge face 14.

Optionally, there is a nailing portion 24 of the panel 10 that has reduced core 16 thickness to accommodate nail heads and nail coverings while maintaining a smooth surface.

At least the bottom major face 20 has a first reinforcing material 26 which is typically embedded in the core 16. Optionally the top major face 22 also has the first reinforcing material 26 which is typically embedded in the core 16.

FIGS. 2 and 2A show selected examples of the cementitious panels 10 of the present invention comprising polymer fabric laminate facing material 30 (also described as polymer composite fabric laminates in the present specification).

In FIG. 2 the reinforcing material 26 extends, across the width of the entire bottom major face 20 from one of the two longitudinal edge faces 14 to the other of the two longitudinal edge faces 14 and wraps around both of the two longitudinal edge faces 14 to contact the top major face 22.

In FIG. 2A a first sheet of the reinforcing material 26 extends, preferably continuously, across at least 95% of the width of the entire bottom major face 20 between one longitudinal edge face 14 to the other longitudinal edge face 14. Also in FIG. 2A, a second sheet of the reinforcing material 26 extends, preferably continuously, across at least 95% of the width of the entire bottom major face 20 between one longitudinal edge face 14 and the other longitudinal edge face 14.

Choice of a reinforcing material 26 generally is determined by the intended use of the panel 10. Choice of a first reinforcing material 26 also depends upon the construction of the hydraulic core 16. Cement based boards 10 generally utilize a fabric, mesh or scrim as the first reinforcing material 26 on the at least one major face 12 of the panel. Gypsum panels 10 are often covered with a multi-ply paper facing.

Plastic sheets and films have also been used as the reinforcing material 26 for one or more of the major faces 12.

The polymer fabric laminate facing material 30 (also named composite fabric laminates in the present specification) is applied primarily to one surface (bottom major surface) 20 of the cementitious panel 10. The fabric edges of the polymer fabric laminate facing material are folded along the panel continuous edges 14 to the other panel surface (top major surface) 22 to facilitate edge formation during the panel manufacturing operation. The polymer fabric laminate facing material 30 in the invention is instrumental in panel formation in a continuous manufacturing operation, wherein the polymer fabric laminate facing material 30 lays over a continuous belt and moves along with the belt at the same speed. The polymer fabric laminate facing material 30 acts as a reservoir to contain the poured cementitious slurry within its confines. The multilayered composite structure of the composite fabric laminate facing material 30, as described herein, prevents the slurry from passing through the composite fabric laminate laminas (also known as layers or plies) and spoiling the belt.

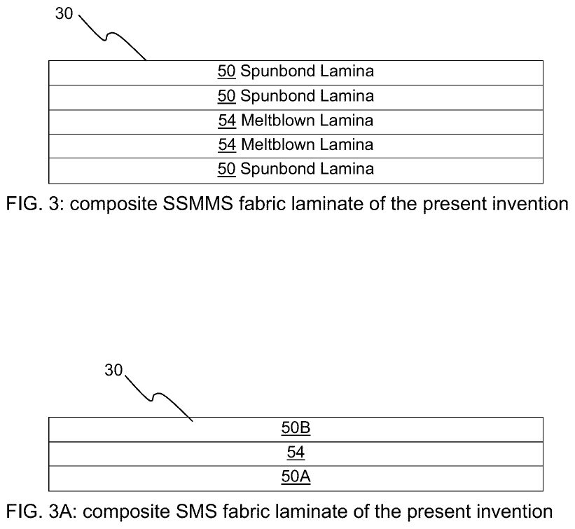

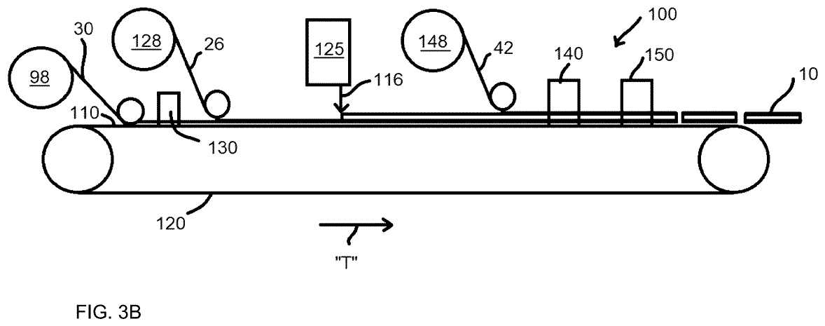

Thus, referring to FIGS. 2 and 3, polymer fabric laminate facing material, generally 30, is preferably applied to bottom major face 20 and to the longitudinal edges 14 that are formed continuously and are parallel to the direction of movement as the panels 10 are formed. The polymer fabric laminate facing material 30 extends, across the width of the entire bottom major face 20 from one longitudinal edge face 14 to the other longitudinal edge face 14 and wraps around both longitudinal edge faces 14 to contact the top major face 22. Thus, the polymer fabric laminate facing material 30 is flexible enough to wrap around the longitudinal edge face 14 of the panel 10.

### Polymer Fabric Laminate Facing Material

The polymer fabric laminate used as facing material in the present invention is a sheet of a multi-lamina laminate (also labeled in this specification as composite laminate). The term polymer fabric laminate signifies that multiple lamina of fibrous materials are assembled to form the finished composite fabric product. Each lamina is a layer or a ply of polymer fabric. Thus, one lamina is also termed in this specification as one ply or one layer. The construction of the polymer fabric laminate facing material is such that each individual lamina of fibrous material possesses its own structure and porosity.

A typical polymer fabric laminate used as facing material in the present invention has a width range of 32″ to 54″ (81 cm to 137 cm). Width will be in the direction transverse to the direction of movement on the cement board manufacturing line. The polymer fabric laminate facing material typically has a fabric laminate weight of 8 gsm to 140 gsm, preferably 9 gsm to 80 gsm, more preferably 10 gsm to 40 gsm, most preferably 11 gsm to 30 gsm.

The composite fabric laminate of the invention is typically nonwoven fabric that can have three or more laminas of nonwoven fibers, wherein, there are at least two spunbond laminas(S) and one meltblown lamina (M). Some selected examples of the composite fabric laminates of the invention include the following construction configurations: SMS, SMMS, SSMSS, SSMS, SSMMS, SSMMSS, SSMMMS, SSMMMSS, SSSMMMSSS, SSMMMMS, SSMMMMSS. Two of those laminas, located on the front and back face of the polymer fabric laminate, have satisfactory open porosity to facilitate slurry absorption, whereas the third lamina is dense and practically impervious to slurry penetration. The laminas with good porosity are ideally made using the spunbond manufacturing method well known in art. Spunbond laminas are nonwoven fabrics that are produced by the spunbond manufacturing process. This process is based on a melt spinning technique that involves extruding molten polymer through a spinneret with a large number of holes to form long continuous fibers. These fibers are then laid down on a moving conveyor belt or web, and they are bonded together to create a nonwoven fabric without the use of weaving or knitting. The web is bonded either thermally, mechanically or chemically, depending on the material and the desired properties in the final fabric. Typically spunbond laminas are made of synthetic polymer, for example, polypropylene, polyethylene, polyester, polyamide (nylon), polyurethane or combinations thereof. Most typically, the polymer is polypropylene, polyethylene, polyester, polyamide (nylon) and copolymers thereof. A spunbond lamina is composed of larger diameter, long, continuous fibers that are virtually unending. The typical diameter of spunbond fibers ranges between 10 and 35 microns, more typically between 10 and 30 microns, for example between 15 and 30 microns. The continuous spunbond fibers and alternating spunbond laminas are thermally welded together. High porosity is a typical characteristic of the spunbond laminas. The porosity and the exposed fibers of the spunbond laminas also facilitate mechanically bonding with slurry.

The lamina with low porosity, i.e., the slurry impervious lamina, is not a non-porous membrane made of continuous film such as that of U.S. Pat. No. 11,865,820. The multi-layered composite fabrics of the present invention are made of discrete, fine-diameter fibers (monofilament fibers) that are assembled to form individual layers of the composite fabric. Thus, the lamina with low porosity, i.e., the slurry impervious lamina, and the lamina with good porosity are made of discrete, fine-diameter fibers. The laminas with low porosity are ideally made using the meltblown manufacturing method well known in art. Melt blowing is a conventional fabrication method of micro- and nanofibers where a polymer melt is extruded through small nozzles surrounded by high speed blowing gas. Meltblown laminas are nonwoven fabrics that are produced by extruding melted polymer fibers through a spin net or die typically having up to 40 holes per inch to form long thin fibers which are stretched and cooled by passing hot air over the fibers as they fall from the die. The resultant web is collected into rolls and subsequently converted to finished products. In particular, the process begins with a polymer resin being melted and extruded through a spinneret, which is a device with tiny holes. Simultaneously, high-speed hot air or gas is blown onto the extruded polymer streams. The force of the air stretches and elongates the molten polymer into very fine fibers, which are then collected on a moving conveyor belt or drum. Typically the polymer is polypropylene, polystyrene, polyester, polyurethane, polyamide (nylon), polyethylene, polycarbonate or copolymers thereof. Most typically, the polymer is polypropylene polyethylene, polyamide (nylon), polyester, or copolymers thereof.

The multi-layered composite fabrics of the present invention are substantially porous due to the open space (or porosity) present between the extensive network of discrete, monofilament fibers of each layer. Each layer of the multi-layered composite fabrics of the present invention has at least some porosity due to the open space (or porosity) present between the extensive network of discrete, monofilament fibers. The lamina with low porosity, i.e., the slurry impervious lamina, has less porosity than the laminas with good porosity. The slurry impervious lamina is sufficiently impervious (has sufficiently low porosity) to make it difficult for cement slurry to pass therethrough and, thus, prevent passage of the cement slurry therethrough at least sufficiently long to make the cement board of the invention. However, the slurry impervious lamina has some porosity and lets water vapors to easily pass through. The multi-layered composite fabric of the present invention has a perm rating of 1.0 perm or greater, preferably 10 perm or greater, more preferably 25 perm or greater, and most preferably 50 perm or greater, for example, with an upper limit of a perm rating of 200 perm, when measured in accordance with ASTM E96 test method. Also, because of their high permeance, the multi-layered composite fabrics utilized in the present invention will not meet the ANSI A118.10 performance standard on their own.

Regarding the lamina with low porosity of the multi-layered composite fabric of the present invention, low porosity is with respect to liquids or liquid water to pass through. This layer can still have very high vapor permeability, i.e., perm rating. The low porosity of this layer (meltblown layer) is due to physical dimensions of the discrete fibers that are very fine in diameter and are very tightly packed owing to their large surface area. The large surface area of fibers leads to tight fiber packing in the lamina, and that provides good resistance from liquids to pass through. Although, the water vapors can still easily pass through the lamina. Typically the lamina with low porosity of the multi-layered composite fabric of the present invention have Layer perm ratings of: >1 perm, preferably >10 perm, more preferably >20 perm, most preferably >50 perm. Typically with an upper limit of a perm rating of 200 perm, when measured in accordance with ASTM E96 test method.

Regarding the lamina with good porosity of the multi-layered composite fabric of the present invention, due to the relatively larger diameter of these fibers compared to the diameter of the fibers of the lamina with low porosity, the lamina is relatively more open (due to lower fiber surface area). The lower surface area of fibers leads to less dense fiber packing in the lamina, and that provides very low resistance to liquids from pass through. Typically the lamina with good porosity of the multi-layered composite fabric of the present invention have Layer perm ratings of: >1 perm, preferably >10 perm, more preferably >20 perm, most preferably >50 perm. Typically with an upper limit of a perm rating of 200 perm, when measured in accordance with ASTM E96 test method.

The lamina with low porosity, i.e., the slurry impervious lamina, is ideally made using the meltblown manufacturing method well known in art. A meltblown lamina is composed of short and fine diameter fibers that form a structure that is very complex and dense making it extremely difficult for liquids to penetrate through. As such, extremely good fluid holding capacity is a typical characteristic of meltblown laminas. The diameter of fibers utilized to make the meltblown lamina as well as the number of meltblown laminas utilized in the overall fabric construction are optimized to provide desired liquid penetration resistance. The diameter of the meltblown fibers ranges from 0.1 microns to 10 microns, for example 0.1 to 9 microns or 0.1 to 5 microns. Preferably, the average diameter of the meltblown fibers in the meltblown lamina is less than 8 microns. The average diameter is a number average. More preferably, the number average diameter of the meltblown fibers in the meltblown lamina is less than 6 microns. Most preferably, the average diameter of the meltblown fibers in the meltblown lamina is less than 4 microns. The diameter of the meltblown fibers can be varied using different methods well known in the art of manufacturing polymer fabric laminates. The meltblown laminas made with finer diameter fibers provide superior liquid penetration resistance. For a given meltblown fiber diameter, increasing the weight and/or number of meltblown laminas provides better liquid penetration resistance. For instance, for a given weight and diameter of meltblown fibers in a fabric laminate, increasing the number of meltblown laminas would provide increasing levels of liquid penetration resistance. Likewise, for a given weight of meltblown fibers and number of meltblown laminas in a fabric laminate, decreasing the diameter of the meltblown fibers would provide better water penetration resistance. The fabric laminates of the invention have at least one meltblown lamina and most preferably, two or more meltblown laminas.

FIG. 3 shows an example of a preferred composite fabric laminate of the invention that is SSMMS fabric laminate-two laminas of meltblown laminas sandwiched between two spunbond laminas on one side and one spunbond lamina on the other side. The five laminas of the composite fabric are stacked on top of each other in the following sequence: spunbond lamina 50/spunbond lamina 52/meltblown lamina 54/meltblown lamina 56/spunbond lamina 60, thus making the composite fabric a SSMMS fabric laminate (FIG. 3). Ideally, the SSMMS laminate of this invention is made of a polymeric material such as polypropylene, polyethylene, polyester, and polyvinyl alcohol. Other materials such as glass fibers and other mineral fiber varieties may also be used to produce the SSMMS laminate of the invention. The composite fabric laminates of the invention can be optimized to be either hydrophilic or hydrophobic. Hydrophobicity or hydrophilicity may be imparted by one or more means including selecting proper fiber material type, tailoring fiber diameter and fabric porosity, and/or using chemical means such as surfactants and coatings. The composite fabric laminates of the present invention can be produced using any of the manufacturing methods well known in art. Details of this spunbond/meltblown/spunbond (SMS) laminate are disclosed in U.S. Pat. No. 4,041,203 to Brock et al. and U.S. Pat. No. 5,169,706 to Collier, et al., each of which is hereby fully incorporated by reference.

FIG. 3A shows a typical polymer fabric laminate facing material 30 for the cementitious panel 10 that is a three-lamina laminate, thus making the composite fabric a SMS fabric laminate. It typically includes a water impermeable lamina 54 that is sandwiched between water permeable laminae 50A, 50B. The water permeable first lamina 50A is configured to become attached to the core 16. Preferably, it is applied to the core 16 slurry and has good porosity to be water permeable so that it is easily bonded to the core 16 by embedding fibers from the first lamina 50A in the core slurry. The term “water-permeable” means that the lamina is permeated by water or water-based systems, such as a gypsum slurry. Preferably, the first lamina 50A is a synthetic fabric that is woven or non-woven. More preferably, the first lamina 50A is a synthetic, non-woven fabric. Many synthetic, non-woven fabrics 50A are known in the art that are made by different processes, and they are equally suitable for use as the polymer fabric laminate facing 30.

One preferred example of a first lamina 50A is a lamina with good porosity of synthetic, non-woven fabric, such as a spunbond fabric. A molten polymer is extruded and spun into long, thin filaments that become entangled and bond to each other while the filaments are still tacky. The spunbond lamina 50A is light weight and water permeable. It has a fabric-like texture and is soft to the touch. When applied to the core 16 slurry, the slurry penetrates the spunbond lamina 50A and the fibers of the innermost lamina become embedded in the matrix structure as the hydraulic binder sets. This action bonds the polymer fabric laminate facing 50A firmly to the panel 10. Thermoplastic polymers, including polypropylene, polyethylene, polyamides and polyesters, or mixtures thereof, are preferred materials for any of the laminas of the polymer fabric laminate facing 30.

There is also the water permeable third lamina 50B of spunbond lamina with good porosity on the outside of the polymer fabric laminate facing 30 such that each of the first lamina 32 and the third lamina 34 are of the spunbond lamina with good porosity. The spunbond lamina of the first lamina 32 is the same or different composition from the second spunbond lamina of the third lamina 34. When both sides of the polymer fabric laminate facing 30 are the same, the polymer fabric laminate facing 30 is reversible and is more convenient to apply since either side is equally suitable for application to the panel 10. The panel 10 also has an exterior surface that is aesthetically pleasing to the eye and comfortable to grip when carrying the panel.

The second lamina 54 is a substantially water impermeable lamina that is bonded to the first lamina 50A and the third lamina 50B. Suitable materials for the second lamina 50 include synthetic woven or non-woven materials. This second lamina 50 is a meltblown lamina. Compared to the spunbond lamina 50A, 50B the meltblown lamina has fibers that are relatively shorter in length and finer in diameter (not shown). They pack together to form a lamina that is denser and much more difficult for water-based systems to penetrate. “Substantially water-impenetrable” means that at relatively low hydrostatic pressure water-based systems do not pass through the material, however when relatively high hydrostatic pressure is applied, water-based systems can push between the short fibers, penetrating the lamina. However, at atmospheric conditions where the polymer fabric laminate facing material 30 is applied and the core 16 material sets, the meltblown lamina 54 prevents the slurry from penetrating through the polymer fabric laminate facing material 30.

The three laminas 50A, 54, 50B may be made individually, collected in rolls and combined in a separate bonding step. Alternately, the SMS Laminate is made by sequentially depositing the first spunbond lamina 50A, then the meltblown lamina 54 and then another spunbond lamina 50B. Prior to extrusion, the polymer is heated above the glass transition temperature. Fibers are extruded from the soft polymer and remain soft and tacky for a short time after extrusion. The laminae 50A, 54, 50B are formed and calendared while the fibers are still tacky, bonding the laminae together without the addition of adhesives. Although the use of adhesives is not detrimental to the finished panel 10, the preferred laminate is made without the use of adhesives. Details of a preferred method of making the SMS Laminate are disclosed in U.S. Pat. No. 4,041,203, incorporated by reference. The polymer fabric laminate material has a plurality of the laminas that are bonded, typically thermally bonded together. Typically the laminas of the polymer fabric laminate material are thermally spot-bonded together using a heated pattern roller.

The fabric laminates of the present invention weigh from 8 to 140 gsm, more preferably from 9 to 80 gsm, even more preferably from 10 to 40 gsm, and most preferably from 11 to 30 gsm.

Other properties of SSMMS polymer fabric laminate facing and SMS polymer fabric laminate facing and that are desirable in the polymer fabric laminate facing 30 is that it readily bonds to adhesives and the third lamina 50B that is visible on the finished panel is aesthetically pleasing. The addition of pigment or dye to the preferred thermoplastic polymer allows it to be made in virtually any color. Further, the surface of the third lamina 50B accepts printing in the form of a pleasing design or words, such as those that would be used to describe the panel 10 to which it is attached. Where the third lamina 50B is a spunbond lamina, its fibers embed themselves in adhesives, providing a secure bond to ceramic tile or any other decorative covering that is applied to the panel 10.

Various important benefits provided by utilization of the composite fabric laminates of the present invention in cement board manufacture are as follows:

Elimination of Release Paper Use & Associated Production Waste—The composite fabric laminates of the present invention allow elimination of release paper use and associated waste generated in the conventional cement board manufacturing operation.

Low Capital Cost—The proposed method of release paper elimination has low capital cost for commercial implementation. Fabric feed equipment to maintain proper fabric tension and fabric tracking along the production line is the primary capital cost driver for practical deployment of the technology.

Panel Manufacturability in Continuous Operations—The composite fabric laminates of the present invention are instrumental in manufacturability of cement board products in continuous production operations. The composite fabric laminates impart the following important features to facilitate manufacturability of cement board products in continuous processes:

The composite fabric laminate has at least one spunbond lamina that directly faces the cementitious core material of the panel. The structure and high porosity of the spunbond lamina allows good slurry infiltration during panel manufacture and hence development of good bond between the spunbond lamina and the cementitious core material.

The meltblown lamina/s situated in the middle of the composite fabric laminate resists and minimizes infiltration of cementitious slurry across. Consequently, the bottom (or outer) spunbond lamina remains completely or substantially free of the cementitious slurry.

The bottom (or outer) spunbond lamina of the composite fabric is completely or substantially free of the slurry. Thus, an important functional aspect of the composite fabric laminate of this invention is that it is instrumental in preventing buildup of slurry on the continuous forming belt located below. Moreover, this feature is also instrumental in providing an aesthetically appealing appearance to the finished cement board product.

Enhanced Bond with Finish Surface Materials—The spunbond lamina on the exposed surface of the cement board is extremely helpful in the application of the finish surfaces (examples, ceramic tiles, cementitious plasters, organic adhesives, etc.) on the panel. Excellent absorptive properties of the spunbond lamina are instrumental in the development of good bond between the finish materials and the substrate panel.

Panel Blocking Prevention-Another important benefit provided by the composite fabric laminate of the present invention is that it acts as a separating layer between the adjacent cementitious panels stacked on top of each other on a pallet. This separation is instrumental in preventing the adjacent panels from sticking to each other. The phenomenon of adjacent panels sticking to each other in cement board manufacturing process is also known as blocking. The tendency for cement boards to block is exacerbated at faster line speeds, particularly when cementitious slurries having a slower set are utilized in cement board manufacture. The use of the composite fabric laminate of the present invention allows the cementitious panels to be stacked on top of each other in a shorter duration after slurry mixing thus eliminating the risk of adjacent panels from sticking to each other or blocking in cement board manufacturing processes.

The use of composite fabric laminate in cement board manufacturing is particularly useful with gypsum-cement formulations wherein the tendency for cement boards to block tends to be greater due to the nature of chemical reactions involved.

Improved Manufacturing Efficiencies—The use of composite fabric laminate of the present invention also helps to improve manufacturing efficiencies as it allows faster manufacturing line speeds without the risk of adjacent cementitious panels from sticking (or blocking) to each other. In addition, the use of composite fabric laminate facilitates reduction in production delays and raw material waste caused by release paper breaks that tend to occur randomly during cement board manufacturing operation.

Enhanced Sustainability Attributes—The use of composite fabric laminate eliminates generation of release paper waste from cement board manufacturing operation thus contributing to the sustainability attributes of the manufactured product and production technology. The use of composite fabric laminate is also instrumental in improving manufacturing efficiencies and reducing production waste thereby enhancing overall sustainability attributes of the product and cement board technology.

Enhanced Product Aesthetics and Edge Durability—The use of composite fabric laminate enhances the overall product appearance including providing a more uniform folded edge appearance as well as a more uniform and aesthetically appealing panel back surface. The use of composite fabric laminate also serves to enhance edge durability and product handling characteristics of cement board products.

Printable Panel Surfaces—The composite fabric laminate provides a uniform surface which can be used for printing product details on the folded edges, back surface, and/or sides of the unit when multiple panels are stacked on top of each other. The composite fabric laminate could be supplied to USG with printing already on it (pre-printed), or alternatively, the actual printing could be accomplished at the time of cement board manufacture.

### Examples of Typical Polymer Composite Laminates of the Invention

Specific examples of some preferred composite nonwoven laminates of this invention are highlighted below.

### Polymer Composite Laminate #1

Product Construction: SSMMS

(Spunbond/Spunbond/Meltblown/Meltblown/Spunbond)

Product Weight: 22 grams/square meter (gsm)

Product Material: Polypropylene

Product Color: Grey or customized

### Polymer Composite Laminate #2

Product Construction: SSMMS

(Spunbond/Spunbond/Meltblown/Meltblown/Spunbond)

Product Weight: 15 grams/square meter

Product Material: Polypropylene

Product Color: White or customized

### Polymer Composite Laminate #3

Construction: SMS/SMMS/SSMMS

Product Weight Range: 10-100 grams/square meter

Composition: Polypropylene

Color: White or customized

### Manufacturing of Cement Boards

Precast concrete products such as cement boards are manufactured most efficiently in a continuous process in which the reactive powder blend is a binder composition and blended with lightweight fillers and other ingredients, followed by addition of water and other chemical additives just prior to placing the mixture in a mold or over a continuous casting and forming belt.

Due to the rapid setting characteristics of the binder composition the mixing of dry components of the binder composition with water usually will be done just prior to the casting operation. Because of the setting of the hydraulic binder composition the cement-based product becomes rigid, and ready to be cut, handled and stacked for further curing.

Thus, the binder composition of the invention is combined with a suitable amount of water to hydrate the reactive powder. Generally, the amount of water added will be greater than theoretically required for the hydration of the reactive powder. This increased water demand is allowed to facilitate the workability of the cementitious slurry. Typically, the weight ratio of the reactive powder to water is about 100:40-70. The amount of water depends on the needs of the individual materials present in the composition.

Gypsum or calcium sulfate dihydrate, if present, form very rapidly in the hydration process thus imparting rapid set and rigidity to the mixtures made with the binder composition of the invention. In manufacturing of cement-based products such as cement boards, if beta calcium sulfate hemihydrate or β-stucco is present, the rapid hydration of beta calcium sulfate hemihydrate or β-stucco, assists to make possible handling of cement boards within a few minutes after the cementitious composition of the invention is mixed with a suitable amount of water.

Setting of the composition is characterized by initial and final set times, as measured using Gilmore needles specified in the ASTM C266 test procedure, as well as high initial compressive strength. The final set time also corresponds to the time when a cement-based product, e.g., a cement board, has sufficiently hardened so that it can be handled. It will be understood by those skilled in the art that curing reactions continue for extended periods after the final setting time has been reached.

In particular, FIG. 2 and FIG. 2A discussed above show selected examples of the cementitious panels 10 of the present invention comprising polymer fabric laminate facing material.

The polymer fabric laminate facing material (also described as a composite fabric) is applied primarily to one major surface (bottom surface) of the cementitious panel and the fabric edges are folded along the panel continuous edges to the outer panel surface to facilitate edge formation during the panel manufacturing operation. The polymer fabric laminate facing material is instrumental in panel formation in a continuous manufacturing operation, wherein the polymer fabric laminate facing material lays over a continuous belt and moves along with the belt at the same speed. The polymer fabric laminate facing material acts as a reservoir to contain the poured cementitious slurry within its confines. The multi-lamina composite structure of the polymer fabric laminate facing material, as described earlier, prevents the slurry from passing through the fabric laminas and spoiling the belt.

The building panel 10 is made by any known method. FIG. 3B schematically shows a board manufacturing line 100 in which the polymer fabric laminate facing material 30 is preferably supplied as a sheet unwound from a roll 98 and positioned on the moving surface 110, in the absence of a release paper between the moving surface and the polymer fabric laminate facing material 30, with the length of the material being parallel to the direction of movement “T” of the moving surface 110. Typically the moving surface 110 is an endless belt conveyor 120. The polymer fabric laminate facing material 30 has a width in a direction transverse to the direction of movement “T” of the moving surface 110 to cover what will become the entire bottom major face 20 and have portions that extend around the longitudinal edges to the top major face 22. Preferably, the polymer fabric laminate facing material 30 has a width of from 4 feet to 10 feet, but any width may be used. Width selection is based upon the thickness and width of the panel and the amount of overlap desired on the major faces 12. The polymer fabric laminate facing material is oriented so that a water permeable lamina is adjacent to the core 16 slurry when it is poured from a mixer or other slurry source 125.

The first reinforcing material 26 for at least one of the major faces 12 is unwound from a roll 128 and positioned on the moving surface 110 with the length of the material 26 being parallel to the direction of movement “T” of the moving surface 110. Preferably the width of the first reinforcing material 26 is approximately the same as the width of the finished panel 10. When placed on the moving surface 110, the width of the polymer fabric laminate facing material 30 overlaps the entirety of the first reinforcing material 26 on the bottom major face 20, the entirety of the longitudinal edges 14, and at least portion of the top major face 22 adjacent the longitudinal edges 14. Preferably, the polymer fabric laminate facing material 30 overlaps between about 10% and about 100% of the top major face 22.

Meanwhile, the hydraulic binder is preferably combined with dry additives, then combined with the wet ingredients to form the aqueous slurry 116. A preferred method of making the building panel 10 includes forming the slurry in a continuous mixer 125 to combine all ingredients. For efficiency in manufacturing, the outlet of the mixer 125 is positioned near the moving surface 110 containing the first reinforcing material 26. As the first reinforcing material 26 and polymer fabric laminate facing material 30 pass near the outlet of the mixer 125, the slurry is discharged in a continuous fashion onto the moving first reinforcing material which is over the polymer fabric laminate facing material 30. The slurry 116 is distributed in any suitable manner (not shown), such as by use of a screed bar which limits the thickness of the slurry and distributes excess slurry to areas with less slurry. When distributed, the slurry 116 preferably extends to the longitudinal edge of the first reinforcing material 26, but does not extend significantly beyond it. As the slurry 116 contacts the bottom overlapping portion 40 of the polymer fabric laminate facing material 30, the first lamina 32 facing the slurry 116 for the core 16 absorbs the slurry 116, thus establishing a good bond between the edge facing and the core 16 that will result after the slurry 116 sets.

After the slurry 116 is formed into the panel, an optional second reinforcing material 42 is unrolled from a roll 148 and applied to the top face 20. Preferably the second reinforcing material 42 extends to the edge of the longitudinal face 14, covering the top face 20.

The portions of the polymer fabric laminate facing material 30 that extend beyond the first reinforcing material 26 is folded toward the longitudinal edge face 14 of the panel 10. The weight of the slurry is sufficient to embed a major portion of the fibers 31 of the first lamina 32 into the core 16 slurry to bond the polymer fabric laminate facing material 30 to the bottom major face 20.

Sufficient pressure is applied to the polymer fabric laminate facing 30 material along the longitudinal edge face 14 in unit 150 to embed at least a major portion of the fibers 31 of the first lamina 32 into the core 16 slurry to bond the polymer fabric laminate facing material 30 to the longitudinal edge face. In the alternative, the polymer fabric laminate facing 30 is optionally folded in a folding unit 130 prior to application of the slurry 116 for the core 16, allowing the slurry to form the longitudinal edge face 14 as it is pressed against the edge facing during panel 10 formation. The order of steps is unimportant as long as the slurry 116 contacts all portions of the polymer fabric laminate facing 30 before the slurry sets and will no longer penetrate the fibers 31 of the first lamina 32.

Preferably the top overlap portions 40 of the polymer fabric laminate facing 30 extends beyond the longitudinal edges 14 and onto the top major face 22 after the longitudinal edge 14 is covered. The overlap portions 40 are what remains of the width of the polymer fabric laminate facing 30 after the bottom face overlap 44 and the overlap with the longitudinal edge 14 portions. In folding unit 140 the overlap portions 44 are folded over the top major face 22 and pressed to the surface to embed fibers of a water permeable lamina, for example the first lamina 50A, into the surface. The top overlap portions 40 are designed to provide additional width to the polymer fabric laminate facing 30 beyond the height of the longitudinal edge face 14 so that if it is not accurately placed, there is sufficient edge facing material to cover the longitudinal edge face 14, maintaining the aesthetically pleasing look and feel of the panel 10. The set structure comprising the set core slurry 116, the polymer fabric laminate facing 30, the first reinforcing material 26 and optionally the second reinforcing material 42 is then cut in a cutting unit 150 into the panels 10.

The cement board production line comprises the necessary fabric feed equipment, well known in the art, to maintain proper fabric tension and fabric tracking along the production line when making the cement board product in a continuous manner. In addition, mechanical edge guides and edge formation equipment are provided along the production line to properly form the cement board edges using the fabric laminate of the invention.

### Binder

Cementitious products with lightweight density are preferred for the boards (panels) of the present invention. Lightweight products of this invention, for example lightweight board, preferably have a density less than 120 pcf, more preferably less than 90 pcf, and most preferably less than 60 pcf. Typically the cementitious panels have a density in the range of about 30 to 120 pcf, more preferably less than 90 pcf, and most preferably less than 60 pcf. Typically on a 0.15 to 2 inches, preferably 0.20 to 1.00 inches, most preferably 0.25 to 0.75 inches thick basis the panels of the invention preferably weigh less than 5 pounds per sq.ft., more preferably less than 4 pounds per sq.ft., and most preferably less than 3 pounds per sq.ft. The compositions and products being set.

Obtaining lightweight density is assisted by employing in the binder compositions employed to make the cores of the panels of the present invention (i) expanded perlite employing special attributes, expanded clay, shale, and/or expanded plastic beads and (ii) air entrainment. Typically obtaining the lightweight density is assisted by employing (i) expanded perlite employing special attributes and (ii) air entrainment.

Thus, the binder composition may comprise lightweight expanded perlite filler. The expanded perlite filler may be present at about 0.01-0.15 perlite: reactive powder weight ratio. The expanded perlite filler is optional and may be 2-10 weight %, 7.5-40 volume % of the binder on a wet basis.

The entrained air represents 10-50% of composite volume on a wet basis. Air-entrainment in the compositions of the invention is provided by means of suitable surfactants that form a stable and uniform structure of air voids in the finished product.

The preferred flexural strength of the boards typically ranges between 400 to 2500 psi when tested per the ASTM C947 standard.

A preferred cement composition for use in this invention includes ingredients listed in TABLE 1.

TABLE 1
Reactive Powders

| Ingredient (weight % of | | | More | Most |
|---|---|---|---|---|
| reactive powder) | Broad | Preferably | preferably | preferably |
| Cement | 10-40 | 20-30 | 25-30 | 27 |
| β-stucco (beta calcium | 30-75 | 40-70 | 50-65 | 60 |
| sulfate hemihydrate) | | | | |
| Pozzolanic material | 5-30 | 5-20 | 7-15 | 10 |
| Calcium hydroxide | Less than | 0.5-3 | 1-3 | 3 |
| (hydrated lime and/or | or equal | | | |
| hydrated dolomitic lime) | to 3 | | | |

A typical such binder composition is an aqueous slurry that comprises a mixture of:
a) a reactive powder comprising
   cement, preferably Portland cement, at about 10-40 wt. % of the reactive powder,
   β-stucco at about 30-75 wt. % of the reactive powder, and pozzolanic material at about 5-30 wt. % of the reactive powder, wherein the pozzolanic material comprises fly ash,
b) a plasticizer in an amount equal to about 0.05-3 wt. %, preferably 0.1-3 wt. %, of the reactive powder, and
c) water, wherein the reactive powder: water weight ratio is 100:40-70.

Typically, the fly ash comprises 0.1-30 wt. % calcium oxide, preferably 0.1-24 wt. % calcium oxide, more preferably up to 18 wt. % calcium oxide.

This binder utilizes fly ash (Class C or F, preferably Class F), a by-product of coal combustion process. The calcium oxide present in the fly ash may be embedded in the glass structure of the fly ash particles, wherein the fly ash may have up to 30 wt. %, up to wt. 25%, up to wt. 10%, between 6-24 wt. %, and between 0.1-30 wt. % calcium oxide. Hydrated lime and/or hydrated dolomitic lime (which is not embedded in the fly ash, cement or any other glass structure) is not included in the calcium oxide in the fly ash. Hydrated lime includes calcium hydroxide and hydrated dolomitic lime includes a combination of calcium hydroxide and magnesium hydroxide.

The binder composition optionally includes 2-10 wt. % perlite, as a lightweight filler, and entrained air, for example 10-50 vol. %, on a wet basis, and optional additives such as water reducing agents, chemical set-accelerators, chemical set-retarders, and crystal nucleating agents, preferably ground gypsum, more preferably, heat resistant accelerators, which are finely ground gypsum, which may be coated with sucrose or dextrose or uncoated. In addition to the perlite, or instead of the perlite, the binder may also optionally contain 0-35 wt. % other lightweight filler, termed in this disclosure as secondary fillers, for example 10-35 wt. % secondary fillers. For example, the binder may contain the 2-10 wt. % perlite as a lightweight filler and 0-35 wt. % additional lightweight fillers as secondary fillers. Typical secondary fillers include one or more lightweight expanded clay, shale aggregate, limestone, expanded plastic beads, hollow glass microspheres, cenospheres, and pumice.

TABLE 2 lists typical additive ranges in accordance with this invention.

TABLE 2
Additive ranges (in an amount equal
to weight % of reactive powder)

| | Preferred | More preferred | Most preferred |
|---|---|---|---|
| Nucleating Agent | 0.1-1.5 | 0.2-1.2 | 0.3-1.1 |
| (HRA) | | | |
| Plasticizer | 0.1-1 | 0.15-0.75 | 0.2-0.5 |
| (preferably PCE*) | | | |
| Aluminum sulfate | 0-1 | 0-0.5 | 0-0.1 |
| (“Alum”) | | | |
| Set Retarder | 0-1 | 0-0.5 | 0-0.1 |

*polycarboxylate ether

TABLE 3 lists formulation ranges in accordance with this binder composition.

TABLE 3
Formulation ranges

| | |
|---|---|
| water/reactive powder weight ratio | 0.40-0.70 |
| Secondary filler/reactive powder weight ratio | 0.01-1.75 |
| *Expanded Perlite/reactive powder weight ratio | 0.05-0.15 |
| Portland cement (wt % of reactive powder) | 20-40 |
| β-Stucco weight (wt % of reactive powder) | 30-75 |
| Fly ash weight (wt % of reactive powder) | 5-30 |

*Expanded perlite/reactive powder weight ratio is a subset of lightweight filler/reactive powder weight ratio.

Another cementitious composition suitable for panels of the present invention includes ingredients listed in TABLE 4.

TABLE 4
Aqueous Mixtures for Cementitious Compositions

| Ingredient | Weight % | Volume % |
|---|---|---|
| Portland cement-based binder (reactive powder) | 35-60 | 10-25 |
| Chemically coated perlite | 2-10 | 7.5-40 |
| Secondary filler, for example expanded clay and | 0-35 | 0-25 |
| shale aggregate | | |
| Water | 20-40 | 20-40 |
| Entrained Air | — | 10-50 |

TABLE 4 describes mixtures used to form the lightweight cementitious compositions of the present invention. The volume occupied by the chemically coated perlite is in the range of 7.5 to 40% and the volume occupied by the entrained air is in the range of 10 to 50% of the overall volume of the composition. This significantly assists in producing cement products having the desired low density of about 40 to 80 pcf (0.64 to 1.28 g/cc), preferably about 45 to 65 pounds per cubic foot (0.72 to 1.04 g/cc).

A typical such cementitious composition aqueous slurry suitable for panels of the present invention includes a mixture of:
35-60 wt. %, on a wet (water inclusive) basis, reactive powder comprising Portland cement and optionally a pozzolanic material (a typical mix included 100 parts Portland cement; 30 parts fly ash; 3 parts land plaster),
2-10 wt. %, on a wet basis, expanded and chemically coated water tight and water repellant perlite filler,
20-40 wt. % water,
10-50 vol. %, on a wet basis, entrained air, at least one optional additive such as water reducing agents, chemical set-accelerators, chemical set-retarders, air-entraining agents, and foaming agents;
0-35 wt. %, typically 10-25 wt. % secondary fillers, for example one or more of expanded clay, shale aggregate and pumice.

Typically, the total of expanded and chemically coated perlite filler and secondary fillers is at least 20 wt. %.

The reactive powder includes Portland cement, and also may include high alumina cement, calcium sulfate, and a mineral additive, preferably fly ash, to form a slurry with water. Reactive powder does not include inert ingredients such as aggregate.

When the reactive powder of the invention includes only Portland cement and fly ash, the reactive powder preferably contains 40-90 wt. % Portland cement and 10-60 wt. % fly ash, or 40-80 wt. % Portland cement and 20-60 wt. % fly ash, wherein wt. % is based on the sum of the Portland cement and fly ash.

The reactive powder may also optionally contain one or other ingredients such as gypsum (land plaster) or high alumina cement added in small dosages to influence the setting and hydration characteristics of the binder. When such other ingredients are present, the reactive powder may contain 40-80 wt. % Portland cement, 0 to 20 wt. % high alumina cement, 0 to 7 wt. % calcium sulfate, and 0 to 55 wt. % fly ash based on the sum of these components.

Thus, the reactive powder blend of the cementitious composition may contain very high concentrations of mineral additives, such as pozzolanic materials, up to 55 wt % of the reactive powder blend. Increasing the content of mineral additives, e.g. fly ash, would help to substantially lower the cost of the product. Moreover, use of pozzolanic materials in the composition helps enhance the long-term durability of the product as a consequence of the pozzolanic reactions.

The reactive powder blend of the cementitious composition may be free of externally added lime. Reduced lime content helps lower the alkalinity of the cementitious matrix and thereby increase the long-term durability of the product.

A typical mix included 100 parts Portland cement; 30 parts fly ash; 3 parts land plaster; expanded and chemically coated perlite filler (2-10% wt.).

### Cement

The cement comprises hydraulic cement, including Portland cement, white cement, slag cements such as blast-furnace slag cement, pozzolan blended cements, expansive cements, sulfoaluminate cements, oil-well cements, preferably Portland cement, more preferably type III Portland cement.

It is to be understood that, as used here, “hydraulic cement” does not include gypsum, which does not gain strength under water, although typically some gypsum is included in Portland cement.

The reactive powder (also termed Portland cement-based binder) may be composed of either pure Portland cement or a mixture of Portland cement and a suitable pozzolanic material such as fly ash or blast furnace slag.

The reactive powder typically includes Portland cement, and also may include high alumina cement, calcium sulfate, and a mineral additive, preferably fly ash, to form a slurry with water. Reactive powder does not include inert materials such as aggregate.

Hydraulic cements useful in the present invention may conform to one or more of the following industry standard specifications, as applicable in the United States:
ASTM C150/C150M-22 (last updated 2022) and/or AASHTO M85 Standard Specification for Portland Cement (2022)
ASTM C595-08a (last updated 2010) and/or AASHTO M240 Standard Specification for Blended Hydraulic Cements (2023)
ASTM C1157/C1157M-23 (last updated 2023) Standard Performance Specification for Hydraulic Cement

When the reactive powder of the invention includes only Portland cement and fly ash, the reactive powder preferably contains 40-90 wt. % Portland cement and 10-60 wt. % fly ash, or 40-80 wt. % Portland cement and 20-60 wt. % fly ash, wherein wt. % is based on the sum of the Portland cement and fly ash.

ASTM C 150 standard specification for Portland cement defines Portland cement as a hydraulic cement produced by pulverizing clinker consisting essentially of hydraulic calcium silicates, usually containing one or more of the forms of calcium sulfate as an inter-ground addition. More generally, other hydraulic cements may be substituted for Portland cement, for example calcium sulfoaluminate based cements. To manufacture Portland cement, an intimate mixture of limestone and clay is ignited in a kiln to form Portland cement clinker. The following four main phases of Portland cement are present in the clinker—tricalcium silicate (3CaO·SiO₂, also referred to as C₃S), dicalcium silicate (2CaO·SiO₂, called C₂S), tricalcium aluminate (3CaO·Al₂O₃ or C₃A), and tetracalcium aluminoferrite (4CaO·Al₂O₃·Fe₂O₃ or C₄AF). The resulting clinker containing the above compounds is inter-ground with calcium sulfates to desired fineness to produce the Portland cement.

The other compounds present in minor amounts in Portland cement include double salts of alkaline sulfates, calcium oxide, and magnesium oxide. Of the various recognized classes of Portland cement, ASTM Type III Portland cement is most preferred in the reactive powder of the binder compositions of the invention. This is due to its relatively faster reactivity and high early strength development.

High alumina cement is also commonly referred to as aluminous cement or calcium aluminate cement. As the name implies, high alumina cements have a high alumina content, about 36-42 wt % is typical. Higher purity high alumina cements are also commercially available in which the alumina content can range as high as 80 wt %. These higher purity high alumina cements tend to be very expensive relative to other cements. High alumina cement and high calcium sulfoaluminate cement may be included but are not preferable due to their expense.

The other compounds present in minor amounts in Portland cement include double salts of alkaline sulfates, calcium oxide, and magnesium oxide. When cement boards are to be made, the Portland cement will typically be in the form of very fine particles such that the particle surface area is greater than 4,000 cm²/gram and typically between 5,000 to 6,000 cm²/gram as measured by the Blaine surface area method (ASTM C 204). Of the various recognized classes of Portland cement, ASTM Type III Portland cement is most preferred in the reactive powder of the cementitious compositions of the invention. This is due to its relatively faster reactivity and high early strength development.

### High Alumina Cement

High alumina cement (HAC) is another type of hydraulic cement that may form a component of the reactive powder blend of some embodiments of the invention.

High alumina cement is also commonly referred to as aluminous cement or calcium aluminate cement. As the name implies, high alumina cements have a high alumina content, about 36-42 wt % is typical. Higher purity high alumina cements are also commercially available in which the alumina content can range as high as 80 wt %. These higher purity high alumina cements tend to be very expensive relative to other cements. The high alumina cements used in the compositions of some embodiments of the invention are finely ground to facilitate entry of the aluminates into the aqueous phase so that rapid formation of ettringite and other calcium aluminate hydrates can take place. The surface area of the high alumina cement that may be used in some embodiments of the composition of the invention will be greater than 3,000 cm²/gram and typically about 4,000 to 6,000 cm²/gram as measured by the Blaine surface area method (ASTM C 204).

Several methods have emerged to manufacture high alumina cement. Typically, the main raw materials for manufacturing high alumina cement are bauxite and limestone. One manufacturing method used in the US for producing high alumina cement is described as follows. The bauxite ore is first crushed and dried, then ground along with limestone. The dry powder comprising bauxite and limestone is then fed into a rotary kiln. A pulverized low-ash coal is used as fuel in the kiln. Reaction between bauxite and limestone takes place in the kiln and the molten product collects in the lower end of the kiln and pours into a trough set at the bottom. The molten clinker is quenched with water to form granulates of the clinker, which is then conveyed to a stock-pile. The granulate is then ground to the desired fineness to produce the final cement.

Several calcium aluminate compounds are formed during the manufacturing process of high alumina cement. The predominant compound formed is monocalcium aluminate (CA). The other calcium aluminate and calcium silicate compounds that are formed include C₁₂A₇, CA₂, C₂S, C₂AS. Several other compounds containing relatively high proportion of iron oxides are also formed. These include calcium ferrites such as CF and C₂F, and calcium alumino-ferrites such as C₄AF, C₆AF₂ and C₆A₂F. Other minor constituents present in the high alumina cement include magnesia (MgO), titania (TiO₂), sulfates and alkalis. It should be noted that tri-calcium aluminate (CsA) seen in ordinary Portland cement is not found in high alumina cements.

### Calcium Sulfate

Various forms of calcium sulfate as shown below may be used in the invention to provide sulfate ions for forming ettringite and other calcium sulfoaluminate hydrate compounds:
Dihydrate—CaSO₄·2H₂O (also known as gypsum)
Hemihydrate—CaSO₄·½ H₂O (also known as stucco)
Anhydrite—CaSO₄ (also known as anhydrous calcium sulfate)

Land plaster is a relatively low purity gypsum and is preferred due to economic considerations, although higher purity grades of gypsum could be used. Land plaster is made from quarried gypsum and ground to relatively small particles such that the specific surface area is greater than 2,000 cm²/gram and typically about 4,000 to 6,000 cm²/gram as measured by the Blaine surface area method (ASTM C 204). The fine particles are readily dissolved and supply the gypsum needed to form ettringite. Synthetic gypsum obtained as a by-product from various manufacturing industries can also be used as a preferred calcium sulfate in the present invention. The other two forms of calcium sulfate, namely, hemihydrate and anhydrite may also be used in the present invention instead of gypsum, i.e., the dihydrate form of calcium sulfate.

### β-Stucco (Beta Calcium Sulfate Hemihydrate)

β-stucco is a particular form of calcium sulfate that may be used in the present invention. β stucco (beta-stucco) and α-stucco (alpha-stucco) have the same CaSO₄·½ H₂O chemical formula but different crystal structure. α-stucco is obtained by heating gypsum under high pressure in the presence of steam or water, whereas steam, water and high pressure are not used to obtain β-stucco. β-stucco is typically produced using rotary calciners, flash calciners, kettle calciners and fluidized bed calciners well known in the art. For instance, in kettle calciners, crushed and/or ground gypsum (natural gypsum rock or synthetic gypsum) is heated outwardly by hot gases passing through flues. Such indirect heating ensures a constant temperature while avoiding overburning and contamination of gypsum with combustion products. The duration of calcination depends upon the moisture content and size of gypsum wherein the temperature of dehydration is typically between 150-180° C. Kettle calciners can operate in either batch or continuous mode.

The crystal structure of α-stucco relatively stubby with a lower aspect ratio. Due to its lower surface area, α-stucco requires less water than β-stucco for workability and offers high strength properties. In contrast to α-stucco, β-stucco is more affordable. The crystal structure of β-stucco gypsum is needle-like and has a higher surface area than α-stucco.

### Pozzolanic Material

The reactive powder blend of the cementitious composition may contain high concentrations of mineral additives, such as pozzolanic materials and/or non-pozzolanic aggregates, for example, calcium carbonate, mica, talc, etc.

ASTM C618-97 defines pozzolanic materials as “siliceous or siliceous and aluminous materials which in themselves possess little or no cementitious value, but will, in finely divided form and in the presence of moisture, chemically react with calcium hydroxide at ordinary temperatures to form compounds possessing cementitious properties.” Various natural and man-made materials have been referred to as pozzolanic materials possessing pozzolanic properties. Some examples of pozzolanic materials include pumice, diatomaceous earth, silica fume, tuff, trass, rice husk, metakaolin, ground granulated blast furnace slag, finely ground glass, and fly ash. All these pozzolanic materials can be used either singly or in combined form as part of the reactive powder of the invention. In certain embodiments, silica fume is excluded from the binder.

Fly ash is the preferred pozzolan in the binders of the invention. Fly ashes containing low calcium oxide content (such as Class F fly ashes of ASTM C618-22 standard) are preferred as explained below.

Fly ash is a fine powder byproduct formed from the combustion of coal. Electric power plant utility boilers burning pulverized coal produce most commercially available fly ashes. These fly ashes consist mainly of glassy spherical particles as well as residues of hematite and magnetite, char, and some crystalline phases formed during cooling. The structure, composition and properties of fly ash particles depend upon the structure and composition of the coal and the combustion processes by which fly ash is formed. ASTM C618 standard recognizes two major classes of fly ashes-Class C and Class F. These two classes of fly ashes are derived from different kinds of coals that are a result of differences in the coal formation processes occurring over geological time periods. Class F fly ashes are normally produced from burning anthracite or bituminous coal, whereas Class C fly ashes are normally produced from lignite or sub-bituminous coal.

The ASTM C618-22 standard differentiates Class F and Class C fly ashes primarily according to their pozzolanic properties. Accordingly, in the ASTM C618-22 standard, the major specification difference between the Class F fly ash and Class C fly ash is the amount of lime or calcium oxide (CaO) in the composition. Class F fly ashes have a maximum lime content of less than 18 wt. %, whereas Class C fly ashes have a lime content of greater than 18 wt. %. Class F fly ashes tend to be more pozzolanic than the Class C fly ashes.

The fly ash comprises Class F fly ash, Class C fly ash, or mixtures thereof, with up to 30 wt. % calcium oxide, which is incorporated in the glass structure on the fly ash particles. Preferably, the fly ash is a Class F fly ash comprising preferably up to 24 wt %, 16 wt. %, up to 6 wt. %, or up to 1 wt. %, most preferably 1-30 wt %, or 4-16 wt. % calcium oxide.

Hydrated Lime and/or Hydrated Dolomitic Lime

Hydrated lime, Ca(OH)₂ and/or hydrated dolomitic lime, Ca(OH)₂-Mg(OH)₂ may be added to the binder composition. This hydrated lime and/or hydrated dolomitic lime is in addition to any bound lime (CaO) in fly ash or cement. Hydrated lime and/or hydrated dolomitic lime is not embedded in a glass structure of a pozzolanic material such as fly ash or the lime embedded in hydraulic cement.

### Perlite

The expanded perlite fillers optionally used in this invention have closed cellular structure. A closed cellular structure helps to minimize particle water absorption and overall water demand of the mixture. This feature, in turn, helps to improve the setting characteristics of the slurry as well as the strength of the finished product. To further reduce water absorption of expanded perlite particles, they are preferably coated with silane, siloxane, silicone or a mixture thereof. This preferred expanded perlite filler is unique in that it is chemically coated for water-tightness and water repellency. Furthermore, the coated expanded perlite filler has a particle size in a range that allows formation of an effective-water-tight closed cell particle structure with the applying of the chemical coating. The use of the selected coated expanded perlite filler is important to allowing preparation of workable and processable slurries at low water usage rates. Lower amounts of water in the composition result in a product having superior mechanical properties and physical characteristics.

The expanded perlite filler is composed of particles having a volume mean diameter, typically between 20-500 microns or 20 to 250 microns, preferably between 20-150 microns, more preferably between 20-125 microns, even more preferably between 20-100 microns, and most preferably between 20-75 microns. For an irregular particle the diameter is the largest dimension of the particle. The expanded perlite filler is composed of particles having an effective particle density preferably less than 0.50 g/cc, more preferably less than 0.40 g/cc, for example 0.10-0.40 g/cc, and most preferably less than 0.30 g/cc, and chemically treated with silane, siloxane, silicone coatings or a mixture thereof. These preferred expanded perlite fillers used in this invention are unique in that the individual perlite particles are chemically coated for water-tightness and water repellency. Octyltriethoxy silane represents a preferred alkyl alkoxy silane to coat perlite for using with the cementitious compositions of this invention.

Furthermore, the coated expanded perlite filler particle size allows formation of an effective-water-tight closed cell particle structure with the applying of the chemical coating. The use of the selected coated expanded perlite filler is important to allowing preparation of workable and processable slurries at low water usage rates. Lower amounts of water in the composition results in a product having superior mechanical properties and physical characteristics. The most preferred chemical coating compounds for making perlite particles water-tight and water repellant are alkyl alkoxy silanes and silicone emulsions comprising mixtures of silanes and/or siloxanes. Octyltriethoxy silane represents the most preferred alkyl alkoxy silane to coat perlite for using with the binder of this invention.

One of the most preferred commercially available chemically coated perlite fillers is SIL-CELL 35-23 available from Silbrico Corporation. SIL-CELL 35-23 perlite particles are chemically coated with alky alkoxy silane compound. Other preferred chemically coated perlite filler are SIL-CELL 35-34, SIL-CELL 32-23, SIL-CELL 42-23, SIL-CELL 43-23, SIL-CELL 50-23, SIL-CELL 32-34, SIL-CELL 35-34, SIL-CELL 43-34, SIL-CELL 43-34, and SIL-CELL 50-34, all available from Silbrico Corporation. SIL-CELL 35-34, SIL-CELL 32-23, SIL-CELL 42-23, SIL-CELL 43-23, SIL-CELL 50-23 particles are coated with a silane coating having a monomer molecular structure, whereas, the SIL-CELL 32-34, SIL-CELL 35-34, SIL-CELL 43-34, SIL-CELL 43-34, and SIL-CELL 50-34 are coated with silicone coating having a polymer molecular structure. DICAPERL 210 and DICAPERL 220 are yet another two commercial coated perlite filler products produced by Grefco Minerals Inc. that are preferred in this invention. DICAPERL 210 perlite, with alkyl alkoxy silane compound is particularly preferred in the binders of the invention. DICAPERL 220 perlite, coated with silicone compound is also useful in the binders of this invention. Another examples of a preferred perlite is MICROSIL 200S from Termolita. Uncoated, closed-cell perlite fillers may also be used in the present invention. An example of suitable closed-cell lightweight filer is SIL-CELL BC from Sllbrico Corporation. Due to their closed-cell structure, these perlite fillers have extremely low water absorption and may be used as a suitable lightweight filler in the compositions of the present invention.

Yet another important benefit results from the small size of the perlite filler particles of this invention. This improvement pertains to the manufacturability and performance characteristics of mesh reinforced cement board products produced using the perlite compositions of the invention. Selected perlite fillers of the invention enhance the overall amount of very fine particles (preferably volume mean diameter less than 150 microns) present in the composition. Presence of high content of fine particles in the composition is extremely useful in rapid processing of mesh reinforced cement board as it helps to improve the bond between the binders and reinforcing mesh as well as the bond between the binders and fabric laminates of the invention. Improved bond of cementitious core with reinforcing mesh and fabric laminate leads to reduced occurrences of mesh and fabric laminate delamination, faster cement board processing speeds, and improved production recoveries.

### Lightweight Fillers and Secondary Fillers

While the disclosed reactive powder blend defines the setting component of the cementitious composition of the invention, it will be understood by those skilled in the art that other materials may be included in the composition depending on its intended use and application.

For instance, for cement board applications, it is desirable to produce lightweight boards without unduly comprising the desired mechanical properties of the product. This objective is achieved by adding lightweight fillers. Examples of useful lightweight fillers include expanded perlite, blast furnace slag, volcanic tuff, pumice, expanded forms of clay, shale, hollow ceramic spheres, hollow plastic spheres, expanded plastic beads, vermiculite, slate, scoria, expanded slag, cinders, glass microspheres, synthetic ceramic microspheres, hollow ceramic microspheres, lightweight polystyrene beads and the like. For producing cement boards, expanded clay and shale aggregates are particularly useful. Expanded plastic beads and hollow plastic spheres when used in the composition are employed in very small quantity on weight basis owing to their extremely low bulk density.

In addition to the perlite lightweight filler, or instead of the perlite lightweight filler, the invention compositions may include additional lightweight fillers, also described in this disclosure as secondary fillers. Lightweight and/or secondary fillers typically have an effective specific gravity (particle density) of less than about 1.75, preferably less than about 1, more preferably less than about 0.75, and still more preferably less than about 0.5. Preferably the effective specific gravity of lightweight and/or secondary fillers is less than about 0.35, more preferably less than about 0.25 and most preferably less than about 0.1. In contrast, inorganic mineral filler preferably has an effective specific gravity above about 2.0.

The specification describes some ingredients as both a pozzolan and a lightweight filler (or a secondary filler). Examples include pumice, volcanic tuff, blast furnace slag, thermally activated clay and shale. When these ingredients exist in expanded form due to natural or industrial thermal activation, they are referred to as a lightweight filler (or a secondary filler) and have an effective specific gravity of less than 1.75. On the other hand, when these ingredients exist in a finely grounded form, they are referred to as pozzolans and have an effective specific gravity greater than 2.0. Furthermore, an ingredient when classified as a pozzolan as per this specification, will have a mean particle size of 30 microns or lower and more typically 20 microns or lower.

Pumice used as lightweight or secondary filler is an aggregate and not a cementitious material or a component of reactive powder. In contrast, pumice used as pozzolanic mineral additive is a non-hydrated form and falls within the ACI CT-13 (ACI Concrete Terminology Standard) definition of a pozzolan as “a siliceous or silico-aluminous material that will, in finely divided form and in the presence of moisture, chemically react with calcium hydroxide at ordinary temperatures to form compounds having cementitious properties (there are both natural and artificial pozzolans)”

Depending on the choice of lightweight filler and secondary fillers selected, the weight ratio of the lightweight filler and secondary fillers to the reactive powder blend may be about 1/100 to 200/100, preferably about 2/100 to 125/100. For example, for making lightweight cement boards, the weight ratio of the lightweight filler and secondary fillers to the reactive powder blend may be about 2/100 to 125/100.

Typically, the total of lightweight filler, for example, expanded perlite filler and secondary fillers, for example expanded clay, shale aggregate and/or pumice, is in an amount equal to at least 20% wt. of the reactive powder.

Moisture content of a lightweight fillers adversely affects the setting time of the binders. Thus, fillers having low water content are preferred in the present invention.

### Plasticizer

Chemical additives such as water reducing agents (plasticizers) may be included in the compositions of the invention and added in the dry form or in the form of a solution. Plasticizers, also known as superplasticizers, may be included in the binder compositions of the invention and added in the dry form or in the form of a solution. Plasticizers help to enhance workability and reduce the water demand of the aqueous mixture. Examples of plasticizers useful in the present invention include polycarboxylate ethers (“PCE”), polyacrylates, polycarboxylates, lignosulfonates, naphthalene sulfonates, melamine sulfonates, and the like.

The plasticizer is present in an amount equal to about 0.05-3 wt. % of the reactive powder, preferably about 2 wt. % or less, preferably about 0.1 to 1.0 wt. %, more preferably about 0.05 to 0.80 wt. %, even more preferably 0.10 to 0.60%, and most preferably about 0.15 to 0.40 wt. %.

The plasticizer may include polycarboxylate ether (“PCE”) plasticizers, for example BASF's LVR Flow 16. U.S. Pat. No. 7,767,019 to Liu et al., incorporated by reference, discloses embodiments of branched polycarboxylates suitable for use as dispersants for the present gypsum slurries. U.S. Pat. No. 10,442,732 to Vilinska et al., incorporated by reference, discloses examples of linear polycarboxylate dispersants. The plasticizer is added to enhance workability and reduce the water demand of the binder.

### Retarders

Use of set retarders as a component in the compositions of the invention is particularly helpful in situations where mixture utilizes lower water amount, or where longer mixing times are involved, or in scenarios where the initial slurry temperature used to form the cement-based products is particularly high, typically greater than 100° F. (38° C.). In these conditions, set retarders such as sodium citrate, citric acid, tartaric acid, potassium tartrate, sodium tartrate, gluconic acid, or DTPA (diethylenetriamine pentaacetate) promote synergistic physical interaction and chemical reaction between different reactive components in the compositions resulting in favorable slurry workability and superior slurry temperature rise response and rapid setting behavior. Without the addition of retarders, stiffening of the reactive powder blend of the invention may occur very rapidly, soon after water is added to the mixture. Rapid stiffening of the mixture is undesirable because it contributes to poor workability and material consolidation, buildup of material in the mixier, inferior product manufacturability, and lower product strength.

The primary function of a retarder in the composition is to keep the slurry mixture from stiffening too rapidly thereby promoting synergistic physical interaction and chemical reaction between the different reactive components. Other secondary benefits derived from the addition of retarder in the composition include reduction in the amount of plasticizer and/or water required to achieve a slurry mixture of workable consistency. Addition of retarder is also instrumental in reducing material buildup in the slurry mixer. All the benefits are achieved due to suppression of premature setting.

Examples of some useful set retarders include sodium citrate, citric acid, potassium tartrate, sodium tartrate, gluconic acid, tartaric acid, DTPA and the like. In the compositions of the invention, sodium citrate, citric acid, and DTPA or mixtures thereof are the preferred set retarders. The set retarders prevent the slurry mixture from stiffening too rapidly. Thus, their addition facilitates product manufacturability in commercial production environments. The retarders may be present in an amount equal to 0.01-1.5 wt. % of the reactive powder, preferably less than 1.0 wt. %, and most preferably less than 0.50 wt. %.

### Alkanolamines

Alkanolamines are amino alcohols that are strongly alkaline and cation active. Examples include triethanolamine [N(CH₂—CH₂OH)₃], monoethanolamine [NH₂(CH₂—CH₂OH)], diethanolamine [NH(CH₂—CH₂OH)₂]. In certain embodiments of the invention, the binder composition excludes alkanolamines. In certain embodiments, the binder excludes triethanolamine (“TEA”).

Addition of alkanolamine alone, or in addition to phosphate (described below), has a significant influence on the rapid setting characteristics of the cementitious compositions of the invention when initiated at elevated temperatures, for example a slurry temperature greater than 90° F. (32° C.). Typically the slurry has an initial temperature of about 90-150° F. (32-66° C.).

If used without phosphate the dosage of alkanolamine, preferably triethanolamine, employed as an accelerator in the slurry is typically about 0.025 to 4.0 wt. %, 0.05 to 2 wt. %, 0.05 to 1 wt. %, 0.05 to 0.40 wt. %, 0.05 to 0.20 wt. %, or 0.05 to 0.10 wt. % based on the weight of reactive powder.

Thus, for example, for every 100 pounds of reactive powder there may be about 0.025 to 4.0 pounds of alkanolamine in the mixture.

### Inorganic Secondary Set Accelerators

In combination with the above-discussed alkanolamines and optional phosphates, other inorganic set accelerators may be added as inorganic secondary set accelerators in the cementitious composition of the invention.

Addition of these inorganic secondary set accelerators is expected to impart only a small reduction in setting time in comparison to the reduction achieved due to the addition of the combination of alkanolamines and optional phosphates. Examples of such inorganic secondary set accelerators include a sodium carbonate, potassium carbonate, calcium nitrate, calcium nitrite, calcium formate, calcium acetate, calcium chloride, lithium carbonate, lithium nitrate, lithium nitrite, aluminum sulfate and the like. The use of calcium chloride should be avoided when corrosion of cement board fasteners is of concern.

The weight ratio of the secondary inorganic set accelerator to the reactive powder blend typically will be less than 2 wt %, preferably about 0.0 to 1 wt %. In other words, for 100 pounds of reactive powder there is typically less than 2 pounds, preferably about 0.0 to 1 pounds, of secondary inorganic set accelerator. These secondary set accelerators can be used alone or in combination.

### Alkali Metal Phosphates

If desired, alkali metal phosphates may optionally be used in the present invention. Such alkali metal phosphates may be one or more of sodium trimetaphosphate (STMP), alkali potassium tripolyphosphate (KTPP) and sodium tripolyphosphate (STPP). These alkali metal phosphates help to strengthen the composition microstructure and increase the strength to density ratio of the final manufactured product.

Alkali metal phosphate is in the composition in an amount equal to 0 to 1.5 wt. %, or 0.15 to 1.5 wt. %, or about 0.3 to 1.0 wt. %, or about 0.5 to 0.75 wt. % of the reactive powder. Thus, for example, for 100 pounds of reactive powder, there may be about 0 to 1.5 pounds of alkali metal phosphate.

### Inorganic Secondary Set Accelerators

In combination with the above-discussed alkanolamines and optional metal phosphates, other inorganic set accelerators may be added as inorganic secondary set accelerators in the binder composition of the invention.

Addition of these inorganic secondary set accelerators is expected to impart only a small reduction in setting time in comparison to the reduction achieved due to the addition of the combination of alkanolamines and optional metal phosphates. Examples of such inorganic secondary set accelerators include a sodium carbonate, potassium carbonate, potassium sulfate, calcium nitrate, calcium nitrite, calcium formate, calcium acetate, calcium chloride, lithium carbonate, lithium nitrate, lithium nitrite, aluminum sulfate and the like. The use of calcium chloride should be avoided when corrosion of cement board fasteners is of concern.

The weight ratio of the secondary inorganic set accelerator to the reactive powder typically will be less than 2 wt %, preferably about 0.0 to 1 wt %. In other words, for 100 pounds of reactive powder there is typically less than 2 pounds, preferably about 0.0 to 1 pounds, of secondary inorganic set accelerator. These secondary set accelerators can be used alone or in combination.

### Slurry Water

The binder composition of the present invention is mixed with water to form a slurry. The water: reactive powder weight ratio ranges between 0.40-0.70, and is preferably 0.44, 0.46, 0.48, 0.50, 0.52, 0.54, 0.56, 0.58, 0.60, 0.62, or 0.70. The temperature of the slurry water used to make cementitious slurry may be warm or cold. With portland cement based formulations, the temperature of the slurry water is typically between 170 to 212° F. On the other hand, with the gypsum-cement formulations, the temperature of the slurry water is typically between 40 to 90° F.

### Other Chemical Additives and Ingredients

Aluminum sulfate may be present in the binder composition in an amount equal to 0-1 wt. % of the reactive powder, preferably 0-0.5 wt. % and most preferably 0.01-0.10 wt. %.

Mineral-based nucleating agents (referred to also as “nucleating agents”) such as finely ground gypsum (with or without chemical treatment) may be present in the binder composition of the invention. Finely ground gypsum nucleating agents, also termed here as heat-resistant accelerators (HRAs), may be present in the binder composition and comprise for example a gypsum powder finely interground with dextrose. In the binder composition of this invention, the heat-resistant accelerator (HRA) may be present in an amount equal to 0.1-1.5 wt. %, preferably 0.3-1.2 wt. %, most preferably 0.5-1.1 wt. % of the reactive powder.

Examples of heat-resistant accelerator (HRA) include finely ground gypsum coated with dextrose and/or sucrose or simply uncoated ground gypsum. An example is further described in U.S. Pat. No. 2,078,199, herein incorporated by reference.

Mineral-based nucleating agents such as finely ground gypsum are beneficial. In some embodiments of the present invention, they allow rapid setting action and strength development of cementitious mixture to enable rapid production of building products on a production line.

Other additives including shrinkage control agents, slurry viscosity modifying agents (thickeners), coloring agents and internal curing agents, may be included as desired depending upon the processability and application of the binder composition of the invention.

### Air-Entraining Agents (Foaming Agents)

When it is desired to produce the present lightweight products such as lightweight cement boards, air-entraining agents (foaming agents) may be added in the composition to lighten the product. Air-entrainment agents are generally suitable surfactants that form a stable and uniform structure of air voids in the finished product. Accordingly, the slurry contains a suitable air entrainment or foaming agent in such amounts to produce the desired degree of air entrainment.

Typically air entraining agents or foaming agents are surfactants, provided in an amount from about 0.0015 to 0.03 wt. %, based upon the total slurry weight. More preferably, the weight of these surfactants ranges between 0.002 to 0.02 wt. %, based upon the total slurry weight. For example, sodium alkyl ether sulfate, ammonium alkyl ether sulfate, sodium alpha olefin sulfonate (AOS), sodium deceth sulfate, ammonium deceth sulfate, sodium laureth sulfate, or sodium dodecylbenzene sulfonate are suitable air entraining and foaming surfactants that can be used in the compositions of the invention.

In the compositions of the invention, externally produced foam is preferably used to reduce slurry and product density. The foam is prepared using suitable surfactants (foaming agents) together with water and air in proper proportions combined in foam generation equipment. The foam so produced is then introduced directly into the wet mixture during the mixing operation while preparing slurry.

Entrained air may be 5-50 vol. % of the binder composition, preferably 10-45 vol. %, most preferably 20-40 vol. %.

### Reinforcing Scrims and Discrete Reinforcing Fibers

Two-dimensional, scrims made of materials such as glass fibers, typically polymer-coated glass fibers, and fibers of polymeric materials such as polypropylene, polyethylene and nylon may be used as the first and second reinforcing materials to reinforce the core depending upon its function and application. Cement boards, produced according the present invention, are typically reinforced with scrims made of polymer-coated glass fibers. One of the preferred polymer coating material for glass fibers is polyvinyl chloride (PVC). Other polymeric materials such as acrylic, SBR, PVA may also be used as coating materials for glass fibers. Alternatively, the reinforcing scrims may also be made of alkali-resistant (AR) glass fibers, wherein the AR glass fiber itself is chemically resistant and does not require a specialized coating for chemical durability. A very small amount of coating may be used with the AR glass fiber scrims for processing reasons during scrim manufacture to keep the multi-directional continuous glass fiber strands in position during and after scrim manufacture. The reinforcing scrims are typically placed near the broad surfaces of the cement board to impart tensile and flexural strength to the composite. The typical embedment depth of the reinforcing scrim from the surface of the board is equal to or less than 1/16″.

Discrete reinforcing fibers of different types may also be included in the binders of the invention. Examples of discrete reinforcing fibers useful in the present invention include alkali-resistant glass fiber, polyvinyl alcohol fibers, polypropylene fibers, polyethylene fibers, nylon fibers, carbon fibers, natural fibers such as paper and cellulose, and steel fibers.

### Clauses of the Invention

The following clauses describe aspects of the invention:

Clause 1. A building composite panel, comprising:
a core of a continuous phase comprising set hydraulic binder, wherein the core comprises first and second opposed longitudinal edge faces, and opposed first and second major faces, each major face adjoining the first and second opposed longitudinal edge faces;
a slurry-permeable reinforcing material attached to the first major face, and optionally attached to the second major face; and,
a polymer fabric laminate facing material, that is different from the reinforcing material, covering and attached, preferably without adhesives, to:
   the first and second longitudinal edge faces,
   an entire width of the first major face from the first longitudinal edge face to the second longitudinal edge face, and
   at least opposed first and second end portions of the second major face adjoining the first and second opposed longitudinal edge faces,
wherein the polymer fabric laminate facing material overlaps the reinforcing material, and
wherein the polymer fabric laminate facing material comprises a plurality of bonded overlapping laminas comprising at least:
   a slurry-permeable first lamina,
   a slurry-impermeable second lamina, and
   a slurry-permeable third lamina,
   wherein the slurry-permeable first lamina and the slurry-permeable third lamina form opposed surfaces of the polymer fabric laminate facing material,
   wherein the slurry-impermeable second lamina is between the slurry-permeable first lamina and the slurry-permeable third lamina,
   wherein the slurry-impermeable second lamina has opposed surfaces, and each of the opposed surfaces of the slurry-impermeable second lamina is directly bonded to a respective lamina of said plurality of laminas,
   wherein the slurry-permeable first lamina is embedded in:
      the first and second longitudinal edge faces,
      an entire width of the first major face from the first longitudinal edge face to the second longitudinal edge face, and
      at least opposed first and second end portions of the second major face adjoining the first and second opposed longitudinal edge faces;
where at least the first lamina is a first web of nonwoven fibers and at least the second lamina is a second web of non-woven fibers, preferably wherein at least the first lamina is made of spunbond fibers and at least the second lamina is made of meltblown fibers.

Clause 2. The panel of clause 1, wherein the polymer fabric laminate facing material has a fabric laminate weight of 8 gsm to 140 gsm, preferably 9 gsm to 80 gsm, more preferably 10 gsm to 40 gsm, most preferably 11 gsm to 30 gsm.

Clause 3. The panel of clause 1, wherein the first lamina comprises a spunbond lamina, wherein said second lamina comprises a meltblown lamina, and wherein the third lamina comprises a spunbond lamina, wherein said second spunbond lamina is made of a different material or same material as said first spunbond lamina.

Clause 4. The panel of clause 1, wherein the fabric laminate comprises at least two meltblown laminas between the slurry-permeable first lamina and the slurry-permeable third lamina.

Clause 5. The panel of clause 1, wherein said laminas of said polymer fabric laminate material are bound together without the use of adhesives.

Clause 6. The panel of clause 1, wherein said laminas of said polymer fabric laminate material are thermally spot-bonded together using a heated pattern roller.

Clause 7. The panel of clause 1, wherein said third lamina readily bonds to adhesives.

Clause 8. The panel of clause 1, wherein each of said laminas comprises at least one of polypropylene, polyethylene, nylon, polyester and copolymers thereof.

Clause 9. The panel of clause 1, wherein at least one of the lamina comprises polypropylene.

Clause 10. The panel of clause 1, wherein at least a portion of said slurry-permeable reinforcing material is embedded in said core between said core and said polymer fabric laminate facing material.

Clause 11. The panel of clause 1, wherein the slurry-permeable reinforcing material is a reinforcing mesh comprising inorganic material, preferably alkali resistant fiberglass.

Clause 12. The panel of clause 1, wherein the board has a thickness of about 0.15 to 20 inches, preferably 0.20 to 1.00 inches, most preferably 0.25 to 0.75 inches, and having a panel density of about 30 to 120, preferably 40 to 80 pcf.

Clause 13. The panel of clause 1, wherein the hydraulic binder comprises calcium sulfate hemihydrate.

Clause 14. The panel of clause 1, wherein the hydraulic binder comprises Portland cement.

Clause 15. The panel of clause 1, wherein the hydraulic binder further comprises one or more of aluminum sulfate, nucleating agent, retarder, alkanolamine, air-entraining agent, phosphate, inorganic secondary set accelerator, lightweight filler, and scrim.

Clause 16. The panel of clause 1, wherein the hydraulic binder further comprises lightweight filler, preferably expanded perlite, expanded clay, expanded shale, and/or expanded plastic beads, wherein the lightweight filler: reactive powder weight ratio is 0.01-1.75:1.00.

Clause 17. The panel of clause 1, wherein the hydraulic binder further comprises perlite filler coated with a member of the group consisting of silane, siloxane, silicone and mixtures thereof.

Clause 18. The panel of clause 1, wherein the hydraulic binder further comprises perlite filler having a volume mean diameter between 20-150 microns.

Clause 19. The panel of clause 1, wherein the continuous phase of the set hydraulic binder resulted from the setting of an aqueous slurry comprising a mixture of water and a reactive powder comprising cement, preferably Portland cement, and optionally β-stucco, and optionally pozzolanic material.

Clause 20. The panel of clause 19, wherein a weight ratio of the reactive powder to water is about 100:40-70.

Clause 21. The panel of clause 1, wherein the continuous phase of the set hydraulic binder resulted from the setting of an aqueous slurry comprising a mixture of:
a reactive powder comprising:
   cement, preferably Portland cement, at about 10-40 wt. % of the reactive powder,
   β-stucco at about 30-75 wt. % of the reactive powder, and pozzolanic material at about 5-30 wt. % of the reactive powder,
   wherein the pozzolanic material comprises fly ash, and water, wherein the reactive powder: water weight ratio is 100:40-70.

Clause 22. The panel of clause 21, wherein the aqueous mixture further comprises:
plasticizer, preferably comprising a polycarboxylate ether (PCE) plasticizer, in an amount equal to about 0.05-3 wt. %, preferably 0.1-3 wt. %, of the reactive powder,
wherein the reactive powder optionally further comprising at least one member of the group consisting of:
a nucleating agent in an amount equal to 0.1-1.5 wt. % of the reactive powder, wherein preferably the nucleating agent comprises a finely ground gypsum powder with or without other chemicals;
aluminum sulfate in an amount equal to about 0.1-1 wt. % of the reactive powder; and
a retarder in an amount equal to about 0.1-1.5 wt. % of the reactive powder, wherein preferably the retarder comprises one or more of sodium citrate, citric acid, gluconic acid, DTPA, potassium tartrate and sodium tartrate.

Clause 23. The panel of clause 21, wherein the fly ash comprises up to 30 wt. % calcium oxide, preferably 0.1-18 wt. % calcium oxide, more preferably 0.1-6 wt. % calcium oxide;
wherein the reactive powder further comprises up to about 3 wt. % hydrated lime and/or hydrated dolomitic lime, which is not embedded in the fly ash, cement, or any other glass structure.

Clause 24. The panel of clause 1, wherein the continuous phase of the set hydraulic binder resulted from the setting of an aqueous slurry comprising a mixture of, on a wet (water inclusive) basis: 35-60 wt. % reactive powder comprising Portland cement and optionally a pozzolanic material, preferably fly ash,
2-10 wt. % expanded perlite filler,
20-40 wt. % water,
0-35 wt %, preferably 10-25, wt. % secondary fillers, wherein the secondary filler is at least one of blast furnace slag, volcanic tuff, expanded clay, shale aggregate, hollow ceramic spheres, hollow plastic spheres, expanded plastic beads, and pumice, and
10-50 volume % entrained air;
wherein the mixture optionally comprises at least one additive selected from the group consisting of chemical set-accelerators, chemical set-retarders, air-entraining agents, and foaming agents an inorganic secondary set accelerator, and water reducing agents, preferably a superplasticizer water reducing agent.

Clause 25. The panel of clause 24, wherein:
the reactive powder comprises 40-90 wt. % Portland cement and 10-60 wt. % fly ash, wherein wt. % is based on the sum of the Portland cement and fly ash; or
the reactive powder comprises 40-80 wt. % Portland cement, 0 to 20 wt. % high alumina cement, 0 to 7 wt. % calcium sulfate, and 0 to 55 wt. % fly ash based on the sum of Portland cement, high alumina cement, calcium sulfate, and fly ash.

Clause 26. A method of providing a panel of any of clauses 1 to 25, comprising:
depositing the polymer fabric laminate facing material directly on a moving forming surface to contact the moving forming surface without a release paper between the polymer fabric laminate facing material and the moving forming surface,
depositing the slurry-permeable reinforcing material onto the slurry-permeable first lamina of the polymer fabric laminate facing material,
depositing a layer of an aqueous slurry comprising water and reactive powder, for setting to become the set hydraulic binder of the core of the panel, on the slurry-permeable reinforcing material, wherein the reactive powder comprises cement, optionally β-stucco, and optionally pozzolanic material, and
folding respective opposed side portions of the polymer fabric laminate facing material around the first longitudinal edge face and the second longitudinal edge face to extend to an upper surface of the deposited slurry,
embedding the slurry in the slurry-permeable first lamina of the polymer fabric laminate facing material; and
forming and setting the aqueous slurry comprising reactive powder to form the set hydraulic binder for the core while there is an absence of release paper between the forming surface and the polymer fabric laminate facing material.

Clause 27. The method of clause 26, wherein the forming surface is a surface of a moving endless belt conveyor, wherein the polymer fabric laminate facing material is deposited directly on the moving endless belt conveyor to contact the moving endless belt conveyor without the release paper between the polymer fabric laminate facing material and the moving endless belt conveyor.

In the examples below, all ratios specified are weight ratios until unless otherwise specified and the acronym “MSF” refers to “1000 square feet” of finished product.

### EXAMPLES

### Example 1

The phenomenon of adjacent panels sticking to each other in cement board manufacturing process is known as blocking. Blocking testing was investigated with two different fabric laminates—15 grams per square meter (gsm) SSMMS fabric (Polymer Composite Laminate #2) and 22 gsm SSMMS fabric (Polymer Composite Laminate #1). The slurry mixture composition utilized is shown in TABLE 5 below. The water/cm ratio utilized in this investigation was 0.46. The test samples were reinforced with fiberglass mesh on both the top and bottom surfaces.

TABLE 5
Example 1 Formulation

| | |
|---|---|
| Slurry Wt. (pounds/MSF) | 2486 |
| Water/cementitious material (cm) Ratio | 0.46 |
| Light Weight Aggregate/cm Ratio | 0.50 |
| Expanded Perlite/cm Ratio | 0.08 |

| | Parts by Weight | pounds/MSF |
|---|---|---|
| Type III Portland Cement | 100 | 302.4 |
| β-Stucco | 260 | 786.2 |
| Class F Fly ash | 40 | 121.0 |
| HRA (heat resistant accelerator, added | 3 | 9.10 |
| as a Powder) | | |
| Total Cements | 403 | 1218.6 |

| | wt % of total cements | |
|---|---|---|
| Light Weight Aggregate | 50 | 609.3 |
| Expanded Perlite | 8 | 97.5 |
| Superplasticizer¹ (44% soln.) | 0.40 | 11.08 |
| Retarder² (4% soln.) | 0.04 | 12.19 |
| Total Liquids | | 560.6 |
| Entrained Air³ (ft³/MSF) | | 11.97 |

¹Polycarboxylate ether (PCE) based superplasticizer
²DTPA
³Air introduced via foam produced using an alkyl ether sulfate surfactant

After the slurry was mixed, it was poured directly onto release paper (control sample) or the fabrics. Two specimens were cast for each test. The pair of specimens were put front to back, similar to the plant production, and then put in a press within 15 minutes after the cast for conducting the blocking test.

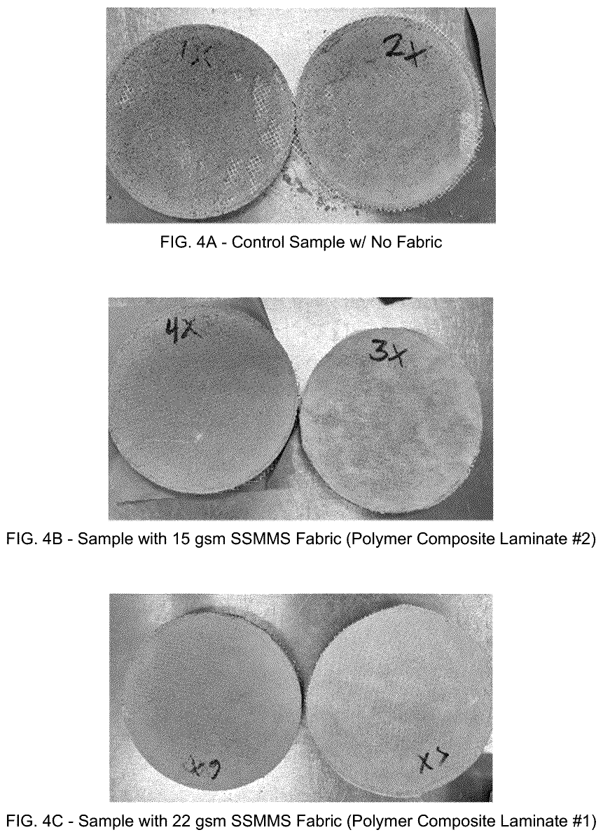

FIGS. 4A, 4B, 4C show the results of the blocking testing for Example 1 (Water/cm ratio of 0.46). The Control sample (FIG. 4A) without the fabric demonstrated significant damage and material transfer when the two pieces were separated, exposing the scrim at some locations. Samples with the fabric showed negligible damage and material transfer, with only some filaments pulling-off and essentially demonstrating no blocking, see FIGS. 4B and 4C. FIG. 4B shows the sample with 15 gsm SSMMS fabric (Polymer Composite Laminate #2). FIG. 4C shows the sample with 22 gsm SSMMS fabric (Polymer Composite Laminate #1). In both pictures, the specimens on the right with light gray/white color were the back side of the cast specimen with the fabrics.

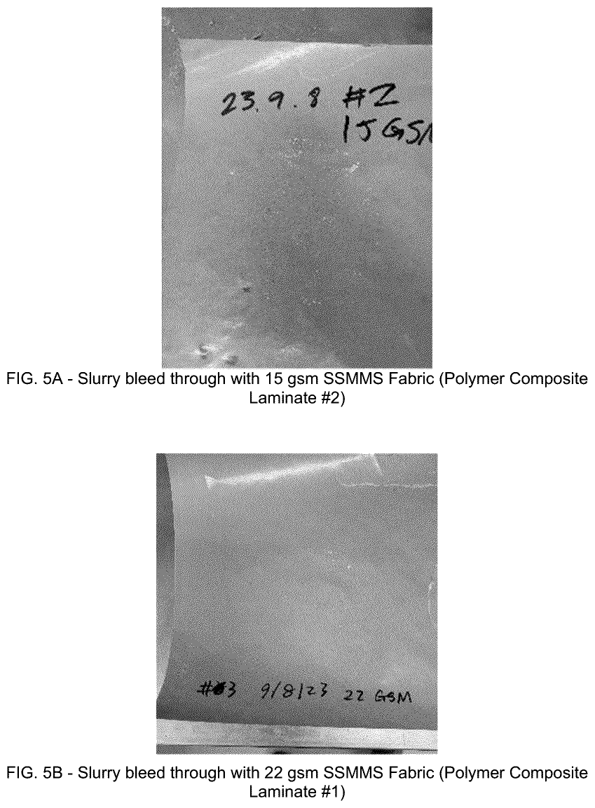

FIGS. 5A, 5B show the slurry bleed through resistance of the fabrics for the 15 gsm and 22 gsm fabric laminates, respectively, for Example 1. FIG. 5A shows slurry bleed through resistance for the 15 gsm SSMMS fabric (Polymer Composite Laminate #2) and FIG. 5B shows slurry bleed through resistance for the 22 gsm SSMMS fabric (Polymer Composite Laminate #1). It can be observed that a negligible amount of material penetrated through the fabrics demonstrating excellent slurry bleed through resistance provided by both fabric laminates.

### Example 2

In this example, blocking test was completed with the 15 gsm SSMMS fabric laminate (Polymer Composite Laminate #2) for mixtures having a higher water/cementitious material ratio of 0.50. The slurry mixture composition utilized is shown in TABLE 6 below. The test samples were reinforced with fiberglass mesh on both the top and bottom surfaces.

TABLE 6
Example 2 Formulation

| | |
|---|---|
| Slurry Wt. (pounds/MSF) | 2486 |
| Water/cm Ratio | 0.50 |
| Lt. Wt. Agg./cm Ratio | 0.50 |
| Expanded Perlite/cm Ratio | 0.08 |

| | Parts by Weight | pounds/MSF |
|---|---|---|
| Type III Portland Cement | 100 | 296.6 |
| β-Stucco | 260 | 771.1 |
| Class F Fly ash | 40 | 118.6 |
| HRA | 3 | 8.90 |
| Total Cements | 403 | 1195.2 |

| | wt % of total cements | |
|---|---|---|
| Lt. Wt. Aggregate | 50 | 595.6 |
| Expanded Perlite | 8 | 95.6 |
| Superplasticizer¹ (44% soln.) | 0.40 | 10.87 |
| Retarder² (4% soln.) | 0.04 | 11.95 |
| Total Liquids | | 597.6 |
| Entrained Air³ (ft³/MSF) | | 11.76 |

¹Polycarboxylate ether (PCE) based superplasticizer
²DTPA
³Air introduced via foam produced using an alkyl ether sulfate surfactant

After the slurry was mixed, it was poured directly onto release paper (control sample) or the fabrics. Two specimens were cast for each test. The pair specimens were put front to back, similar to the plant production, and then put in a press within 15 minutes after the cast for conducting the blocking test.

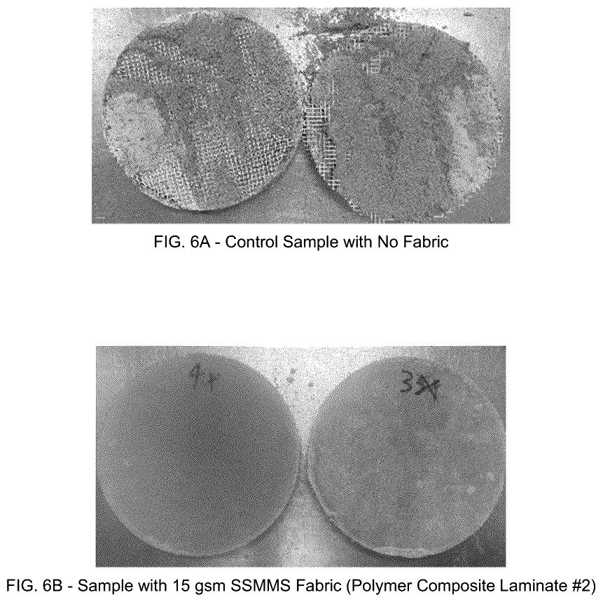

FIGS. 6A, 6B show the results from the Blocking testing for Example 2 (w/cm-0.50). FIG. 6A shows the Control sample without the fabric demonstrated significant damage and material transfer when the two pieces were separated, exposing the scrim at some locations. FIG. 6B shows the sample with 15 gsm SSMMS Fabric showed negligible damage and material transfer, with only some filaments pulling-off and essentially demonstrating no blocking.

### Example 3

An experiment using similar methods to the previous two examples was conducted using much heavier fabric materials. The heaviest fabric investigated was a 68 gsm spunbond material—a single lamina spunbond fabric, termed here as Fabric HVY. The lighter fabric investigated was a 48 gsm SMS fabric laminate—a three layered laminate, termed here as Fabric LWT. Both fabrics were made of polypropylene. The results of the experiment further clarified some highly specific fabric material properties needed for successful industrial production of cementitious panel products.

TABLE 7 shows the formulation used in all 3 sets of the blocking tests run.

TABLE 7

| | |
|---|---|
| Slurry Wt. (pounds/MSF) | 2485 |
| Water/cementitious material | 0.58 |
| (cm) Wt. Ratio | |
| Lt. Wt. Agg./cm Ratio | 0.50 |
| Expanded Perlite/cm Ratio | 0.08 |

| | Parts by Weight | pounds/MSF |
|---|---|---|
| Type III Portland Cement | 100 | 296.6 |
| β-Stucco | 260 | 771.1 |
| Fly ash Class F | 40 | 118.6 |
| HRA | 3 | 8.90 |
| Total Cements | 403 | 1195.2 |

| | wt % of total cements | |
|---|---|---|
| Light Weight Aggregate | 42 | 502.1 |
| Expanded Perlite | 7.6 | 91.3 |
| Superplasticizer¹ (44% soln.) | 0.40 | 10.87 |
| Retarder² (4% soln.) | 0.03 | 8.96 |
| Total Liquids | | 597.6 |
| Entrained Air³(ft³/MSF) | | 11.76 |

¹Polycarboxylate ether (PCE) based superplasticizer
²DTPA
³Air introduced via foam produced using an alkyl ether sulfate surfactant

After the slurry was mixed, it was poured directly onto release paper (control sample) or the fabrics. Two specimens were cast for each test. The pair specimens were put front to back, similar to the plant production, and then put in a press within 15 minutes after the cast for conducting the blocking test.

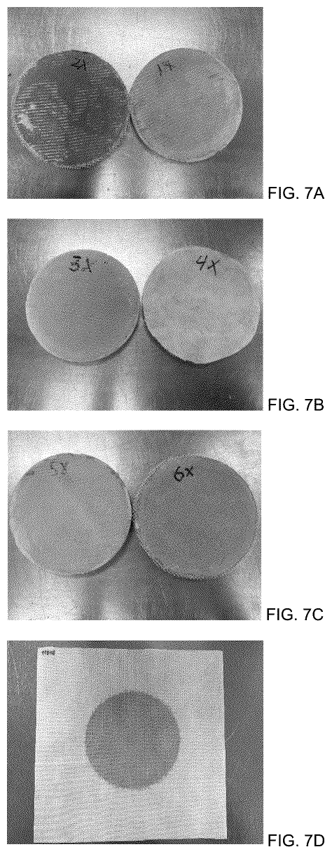

Blocking results for the Control Sample (without fabric) are shown in FIG. 7A. Significant blocking and panel damage can be observed in the photograph.

Experimental results for the samples with the Fabric LWT are shown in FIG. 7B. The blocking prevention with this fabric was excellent, however, fabric bond to the cementitious core was less than ideal since there were signs of fabric delamination on the sample edges. Excessive slurry absorption into the fabric was probably the main reason for the observed delamination. This is explained in more detail in the next experiment with the heavier fabric, Fabric HVY.

Experimental results for the Fabric HVY are shown in FIG. 7C. Significant absorption of the slurry into the fabric was noticeable wherein the slurry profusely penetrated through the fabric thickness. This occurred because the fabric was made entirely of spunbond material and did not have a meltblown component in it. Moreover, complete delamination of the fabric from the cementitious core was observed. The observed fabric delamination most likely resulted due to the fact that bulk of the slurry between the scrim plane of the board and the surface of the fabric was soaked into the fabric. This left not enough slurry at the interface to form a sufficient bond. The delaminated Fabric HVY is shown in FIG. 7D.

The above experiments demonstrate that careful selection of composite fabrics having suitable moisture wicking/permeability properties, ability to mechanically bond with a very small layer of slurry, ability to block slurry penetration through the fabric thickness, ability to bond with various mortars on the outward face of the fabric, etc. leads to successful industrial implementation of this technology.

### Example 4

This examples demonstrates the performance of 22 gsm SSMMS fabric laminate (Polymer Composite Laminate #1) and 15 gsm SSMMS fabric laminate (Polymer Composite Laminate #2) with portland cement based formulation. The portland cement based mixture composition utilized in this example is shown in TABLE 7. The prepared cementitious slurry was poured onto the fabric laminates to evaluate the slurry bleed through resistance of the fabric laminates. The water to cementitious materials ratio utilized in this investigation was 0.57.

TABLE 7
Example 4 Formulation

| | |
|---|---|
| Slurry Wt. (pounds/MSF) | 2385 |
| Water/cm Ratio | 0.57 |
| Lt. Wt. Agg./cm Ratio | 0.44 |
| Expanded Perlite/cm Ratio | 0.08 |

| | Parts by Weight | pounds/MSF |
|---|---|---|
| Type III Portland Cement | 100 | 891.5 |
| Fly ash Class F | 20 | 178.3 |
| Landplaster | 8 | 71.3 |
| Total Cements | 128 | 1141.1 |

| | wt % of total cements | |
|---|---|---|
| Lt. Wt. Aggregate | 44 | 502.1 |
| Expanded Perlite | 8 | 91.3 |
| TEA (85% soln.) | 0.20 | 2.68 |
| STMP (5% soln.) | 0.04 | 9.13 |
| Sodium citrate (10% soln.) | 0.20 | 22.82 |
| Superplasticizer¹ (40% soln.) | 0.16 | 4.56 |
| Total Liquids | | 650.4 |
| Entrained Air² (ft³) | | 12.90 |

¹Naphthalene sulfonate based superplasticizer
²Air introduced via foam produced using an alpha olefin sulfonate surfactant

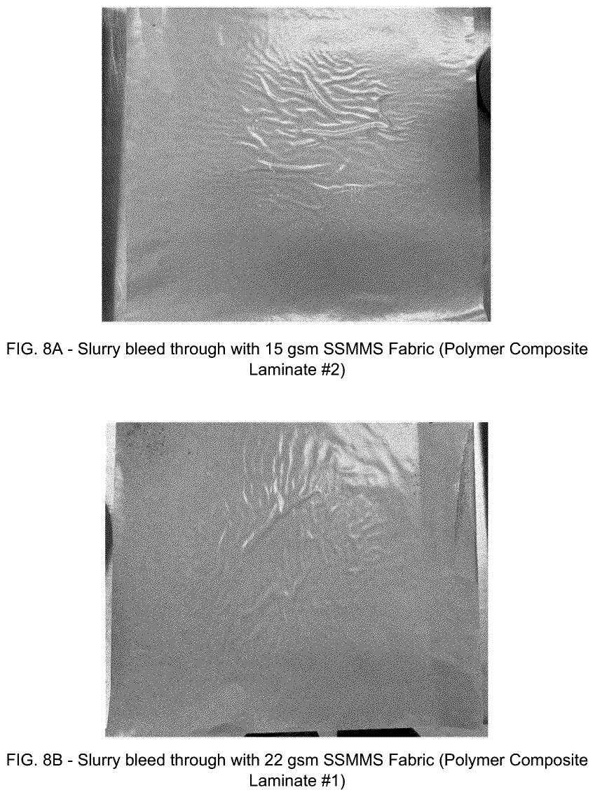

After the slurry was mixed, it was poured directly onto the fabrics. The results from the bleed through test are shown in FIGS. 8A and 8B. FIG. 8A shows bleed through resistance of fabric for 15 gsm SSMMS Fabric (Polymer Composite Laminate #2). FIG. 8B shows bleed through resistance of fabric for 22 gsm SSMMS Fabric (Polymer Composite Laminate #1). Both fabric laminates demonstrated excellent bleed through resistance. The results also clearly demonstrated the potential for eliminating the release paper in industrial cement board production by utilizing fabric laminates as described in this example.

### Example 5

In this example, four (4) different SSMMS fabric laminates were investigated. All four fabrics had SSMMS construction. The meltblown fibers used in these fabric laminates were finer in diameter and were more uniformly distributed in the individual meltblown laminas compared to the fabric laminates, Polymer Composite Laminate #1 and Polymer Composite Laminate #2, described in the previous examples. This was achieved by controlling various manufacturing process variables, such as polymer melt viscosity, well known in the art of manufacturing non-woven polymer fabrics.

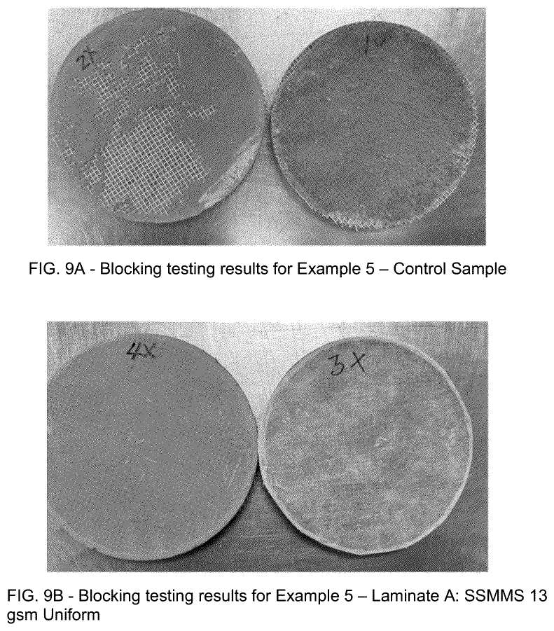

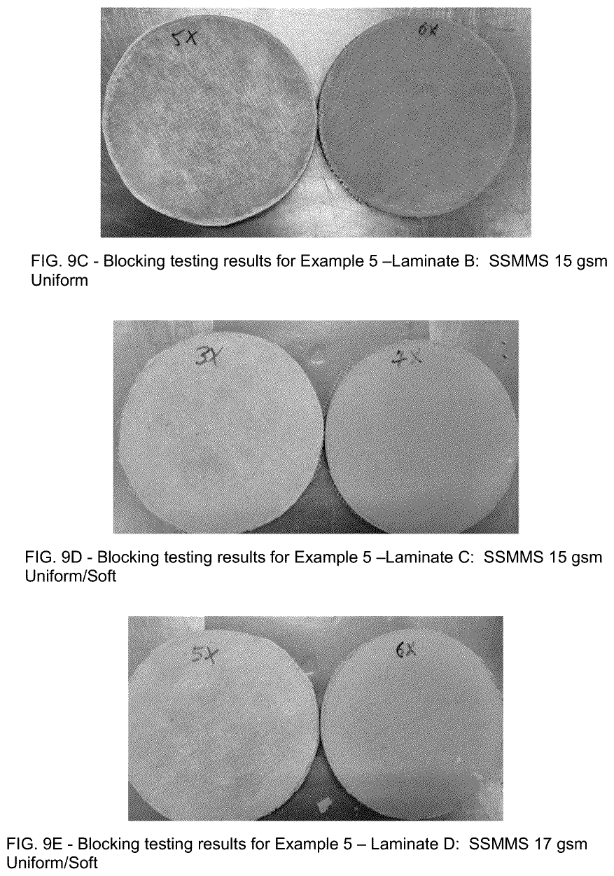

All four fabric laminates used in this example had SSMMS construction and were made of polypropylene material. These fabrics laminates were classified as follows:
FIG. 9A, Control Sample, without the fabric
FIG. 9B, Laminate A: SSMMS 13 gsm Uniform
FIG. 9C, Laminate B: SSMMS 15 gsm Uniform
FIG. 9D, Laminate C: SSMMS 15 gsm Uniform/Soft
FIG. 9E, Laminate D: SSMMS 17 gsm Uniform/Soft

The slurry mixture composition utilized in this example is shown in TABLE 8. The test samples were reinforced with fiberglass mesh on both the top and bottom surfaces. The control sample was made without fabric.

TABLE 8
Example 5 Formulation

| | |
|---|---|
| Slurry Wt. (pounds/MSF) | 2486 |
| Water/cm Ratio | 0.50 |
| Lt. Wt. Agg./cm Ratio | 0.50 |
| Expanded Perlite/cm Ratio | 0.08 |

| | Parts by Weight | pounds/MSF |
|---|---|---|
| Type III Portland Cement | 100 | 296.6 |
| β-Stucco | 260 | 771.1 |
| Fly ash Class F | 40 | 118.6 |
| HRA | 3 | 8.90 |
| Total Cements | 403 | 1195.2 |

| | wt % of total cements | |
|---|---|---|
| Lt. Wt. Aggregate | 50 | 595.6 |
| Expanded Perlite | 8 | 95.6 |
| Superplasticizer¹ (44% soln.) | 0.40 | 10.87 |
| Retarder² (4% soln.) | 0.03 | 8.96 |
| Total Liquids | | 597.6 |
| Entrained Air³ (ft³/MSF) | | 11.76 |

¹Polycarboxylate ether (PCE) based superplasticizer
²DTPA
³Air introduced via foam produced using an alkyl ether sulfate surfactant

After the slurry was mixed, it was poured directly onto release paper (control sample) or the fabrics. Two specimens were cast for each test. The pair specimens were put front to back, similar to the plant production, and then put in a press within 15 minutes after the cast for conducting the blocking test.

The results from the blocking test are shown in FIG. 9. The Control Sample, FIG. 9A, without the fabric demonstrated significant damage and material transfer when the two pieces were separated, exposing the scrim at some locations. Samples with various fabrics showed negligible damage or material transfer, FIGS. 9A through 9E.

### Example 6

In this example, a 39″ wide continuous roll of the 22 gsm SSMMS fabric laminate (Polymer Composite Laminate #1) was used to investigate industrial manufacturability of cement boards in a continuous manufacturing process in absence of release paper. The formulation utilized is shown in TABLE 9.

TABLE 9
Formulation for Example 6

| | |
|---|---|
| Slurry Wt. (pounds/MSF) | 2486 |
| Water/cm Ratio | 0.46 |
| Lt. Wt. Agg./cm Ratio | 0.50 |
| Expanded Perlite/cm Ratio | 0.08 |

| | Parts by Weight | pounds/MSF |
|---|---|---|
| Type III Portland Cement | 100 | 302.3 |
| β-Stucco | 260 | 785.9 |
| Fly ash | 40 | 120.9 |
| HRA | 3 | 9.1 |
| Total Cements | 403 | 1218.2 |

| | wt % of total cements | |
|---|---|---|
| Lt. Wt. Aggregate | 50 | 609.1 |
| Expanded Perlite | 8 | 97.5 |
| Superplasticizer¹ (44% soln.) | 0.35 | 9.70 |
| Retarder² (4% soln.) | 0.02 | 6.09 |
| Total Liquids | | 560.0 |
| Entrained Air³ (ft³/MSF) | | 11.97 |

¹Polycarboxylate ether (PCE) based superplasticizer
²DTPA
³Air introduced via foam produced using an alkyl ether sulfate surfactant

After the different materials were mixed, the slurry was poured directly on to the continuously moving fabric laminate (with fiberglass scrim laid on top of fabric) to form a ½″ thick and 36″ wide continuous ribbon of cementitious panel product. Continuous fiberglass meshes were used as reinforcement on the top and bottom surfaces of the formed panel. The bottom mesh rested on top of the said continuous fabric laminate. No release paper was used in the production.

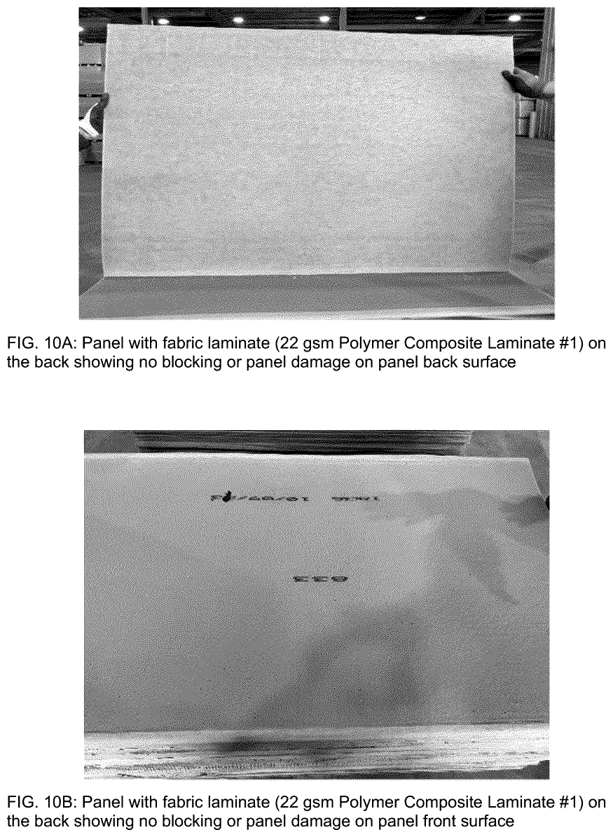

No visible slurry penetration was observed through the fabric on to the continuous carriage belt. It took about 8 minutes for the cast material to reach the palletizer located at the end of the line after materials were mixed to form the slurry. At the end of the line, the continuous moving ribbon of formed product was cut periodically at five (5) feet intervals using an online circular saw to form 3′×5′ discrete panels. At the end of the line, the panels were stacked on top of each other on a wooden pallet with 50 pieces per pallet. A stack of four such pallets was created in the warehouse with pallets resting on top of each other. The pallets were cured in ambient condition in the warehouse for 2 days. After 2 days, the panels at the bottom of the 4-pallet stack were inspected for blocking and material damage. No blocking or material damage was observed, FIG. 10A and FIG. 10B, showing the effectiveness of fabric in maintaining the integrity of the panels. FIG. 10A shows a panel with fabric laminate (22 gsm Polymer Composite Laminate #1) on the back showing no blocking or panel damage on the panel back surface. FIG. 10B shows a panel with fabric laminate (22 gsm Polymer Composite Laminate #1) on the back showing no blocking or panel damage on the panel front surface.

Preferred embodiments of this invention are described herein. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. A building composite panel, comprising:
a core of a continuous phase comprising set hydraulic binder, wherein the core comprises first and second opposed longitudinal edge faces, and opposed first and second major faces, each major face adjoining the first and second opposed longitudinal edge faces;
a slurry-permeable reinforcing material attached to the first major face, and optionally attached to the second major face; and,
a polymer fabric laminate facing material, that is different from the reinforcing material, covering and attached to:
the first and second longitudinal edge faces,
an entire width of the first major face from the first longitudinal edge face to the second longitudinal edge face, and
at least opposed first and second end portions of the second major face adjoining the first and second opposed longitudinal edge faces,
wherein the polymer fabric laminate facing material overlaps the reinforcing material, and
wherein the polymer fabric laminate facing material comprises a plurality of bonded overlapping laminas comprising at least:
a slurry-permeable first lamina,
a slurry-impermeable second lamina, and
a slurry-permeable third lamina,
wherein the slurry-permeable first lamina and the slurry-permeable third lamina form opposed surfaces of the polymer fabric laminate facing material,
wherein the slurry-impermeable second lamina is between the slurry-permeable first lamina and the slurry-permeable third lamina,
wherein the slurry-impermeable second lamina has opposed surfaces, and each of the opposed surfaces of the slurry-impermeable second lamina is directly bonded to a respective lamina of said plurality of laminas,
wherein the slurry-permeable first lamina is embedded in:
the first and second longitudinal edge faces,
an entire width of the first major face from the first longitudinal edge face to the second longitudinal edge face, and
at least opposed first and second end portions of the second major face adjoining the first and second opposed longitudinal edge faces;
where at least the first lamina is a first web of nonwoven fibers and at least the second lamina is a second web of non-woven fibers.

2. The panel of claim 1, wherein at least the first lamina is made of spunbond fibers and at least the second lamina is made of meltblown fibers.

3. The panel of claim 1, wherein the polymer fabric laminate facing material has a fabric laminate weight of 8 gsm to 140 gsm.

4. The panel of claim 1, wherein the first lamina comprises a spunbond lamina, wherein said second lamina comprises a meltblown lamina, and wherein the third lamina comprises a spunbond lamina, wherein said second spunbond lamina is made of a different material or same material as said first spunbond lamina.

5. The panel of claim 1, wherein the fabric laminate comprises at least two meltblown laminas between the slurry-permeable first lamina and the slurry-permeable third lamina.

6. The panel of claim 1, wherein said laminas of said polymer fabric laminate material are bound together without the use of adhesives.

7. The panel of claim 1, wherein said laminas of said polymer fabric laminate material are thermally spot-bonded together using a heated pattern roller.

8. The panel of claim 1, wherein each of said laminas comprises at least one of polypropylene, polyethylene, nylon, polyester and copolymers thereof.

9. The panel of claim 1, wherein at least one of the lamina comprises polypropylene.

10. The panel of claim 1, wherein at least a portion of said slurry-permeable reinforcing material is embedded in said core between said core and said polymer fabric laminate facing material.

11. The panel of claim 1, wherein the slurry-permeable reinforcing material is a reinforcing mesh comprising inorganic material.

12. The panel of claim 1, wherein the board has a thickness of about 0.15 to 20 inches and having a panel density of about 30 to 120.

13. The panel of claim 1, wherein the hydraulic binder comprises calcium sulfate hemihydrate.

14. The panel of claim 1, wherein the hydraulic binder comprises Portland cement.

15. The panel of claim 1, wherein the hydraulic binder further comprises one or more of aluminum sulfate, nucleating agent, retarder, alkanolamine, air-entraining agent, phosphate, inorganic secondary set accelerator, lightweight filler, and scrim.

16. The panel of claim 1, wherein the hydraulic binder further comprises lightweight filler, wherein the lightweight filler: reactive powder weight ratio is 0.01-1.75:1.00.

17. The panel of claim 1, wherein the hydraulic binder further comprises perlite filler coated with a member of the group consisting of silane, siloxane, silicone and mixtures thereof.

18. The panel of claim 1, wherein the continuous phase of the set hydraulic binder resulted from the setting of an aqueous slurry comprising a mixture of water and a reactive powder comprising cement, and optionally β-stucco, and optionally pozzolanic material.

19. A method of providing a panel of claim 1, comprising:
depositing the polymer fabric laminate facing material directly on a moving forming surface to contact the moving forming surface without a release paper between the polymer fabric laminate facing material and the moving forming surface,
depositing the slurry-permeable reinforcing material onto the slurry-permeable first lamina of the polymer fabric laminate facing material,
depositing a layer of an aqueous slurry comprising water and reactive powder, for setting to become the set hydraulic binder of the core of the panel, on the slurry-permeable reinforcing material, wherein the reactive powder comprises cement, optionally β-stucco, and optionally pozzolanic material, and
folding respective opposed side portions of the polymer fabric laminate facing material around the first longitudinal edge face and the second longitudinal edge face to extend to an upper surface of the deposited slurry,
embedding the slurry in the slurry-permeable first lamina of the polymer fabric laminate facing material; and
forming and setting the aqueous slurry comprising reactive powder to form the set hydraulic binder for the core while there is an absence of release paper between the forming surface and the polymer fabric laminate facing material.

20. The method of claim 19, wherein the forming surface is a surface of a moving endless belt conveyor, wherein the polymer fabric laminate facing material is deposited directly on the moving endless belt conveyor to contact the moving endless belt conveyor without the release paper between the polymer fabric laminate facing material and the moving endless belt conveyor.
